(19) United States
(12) Patent Application Publication
(10) Pub. No.: US 2024/0294776 A1
(43) Pub. Date: Sep. 5, 2024

(54) GLASSY ANTIFOULING COATINGS AND METHODS FOR MAKING AND USING THE SAME

(71) Applicant: Florida State University Research Foundation, Inc., Tallahassee, FL (US)

(72) Inventors: John Akintola, Tallahassee, FL (US); Joseph Schlenoff, Tallahassee, FL (US)

(21) Appl. No.: 18/442,166

(22) Filed: Feb. 15, 2024

Related U.S. Application Data
(60) Provisional application No. 63/445,929, filed on Feb. 15, 2023.

(51) Int. Cl. C09D 5/16; C08F 212/08; C08F 212/14; C08F 226/02; C08F 226/06; C08G 61/12; C08G 65/26; C08G 65/40; C08G 75/029; C08G 75/14; C08G 75/20; C09D 7/20

(52) U.S. Cl. CPC C09D 5/1637; C08F 212/08; C08F 212/30; C08F 226/02; C08F 226/06; C08G 61/124; C08G 65/2636; C08G 65/4012; C08G 75/029; C08G 75/14; C08G 75/20; C09D 7/20; C08G 2650/40

(57) ABSTRACT

Described herein are articles coated with one or more polyelectrolyte complexes. The polyelectrolyte complexes have a high glass transition temperature when the coating is contacted with an aqueous medium. In one aspect, the coating has a glass transition temperature of at least 45° C. when in contact with an aqueous medium, which makes the coatings described herein as “glassy.” The coating compositions described herein are effective in reducing adhesion of organisms on the surface of the coated article, which makes the coatings an effective antifouling coating.

### CROSS-REFERENCE TO RELATED APPLICATIONS

This application claims the benefit of and priority to co-pending U.S. Provisional Patent Application No. 63/445,929, filed on Feb. 15, 2023, the contents of which are incorporated by reference herein in its entirety.

### STATEMENT REGARDING FEDERALLY SPONSORED RESEARCH OR DEVELOPMENT

This invention was made with government support under DMR 2103703 awarded by the National Science Foundation. The government has certain rights in the invention.

### BACKGROUND

In marine environments, organisms from the micro- to the macro- scale foul surfaces under a variety of mechanisms. Fouling increases fuel consumption, decreases service life, accelerates corrosion and brings with it the possibility of introducing invasive species into aquatic ecosystems. Both vessels and installations/infrastructure are subject to fouling. The progress of fouling includes both sequential and simultaneous elements from a broad variety of biological or bio-derived agents.

Antifouling and fouling release surfaces represent one of the most stringent challenges in materials and surface science. This is because Nature has evolved a plethora of mechanisms by which organisms may attach to surfaces—a property needed for their survival. Historically, practical antifouling or nonfouling coatings have relied heavily on toxic components to actively discourage fouling. As environmental concerns surrounding toxic coatings have increased, tin has given way to copper and a variety of organic biocides as active antifouling components in marine paints. Fluorinated hydrocarbons also generate environmental concerns, due to the inertness and thus “forever” qualities of some fluorinated materials, especially those used to make surfaces “nonstick.”

Some currently-used antifouling coatings are designed to allow the removal of accumulated biomaterials under shear—fouling release—a property claimed by some polydimethylsiloxanes (PDMS). Other coatings are designed to hydrolyze slowly promoting loss of adhesion under shear in these self-polishing formulations. In the ideal passive antifouling surface, the physical and chemical characteristics of the surface are sufficient to deter adhesion under static conditions. In practice, the line between antifouling and fouling release is sufficiently blurred such that a small amount of shear may be required to remove a colony of organisms adhering to a “passive” antifouling surface.

Materials for passive antifouling coatings have many properties in common. They are usually neutral or weakly negative, and well hydrated. Numerous hydrophilic, net-neutral monomers and polymers have been pressed into service, including acrylamides, polysaccharides (e.g. mannitol), and, most commonly, polymers or oligomers based on the ethylene glycol, EG, (—CH₂—CH₂—O—) repeat unit, termed PEGs. “PEGylation” refers, in addition to general antifouling applications, to the modification of a molecule or surface with EG repeat units to decrease interactions in a biological environment and therefore enhance the circulation (of molecules and nanoparticles) or residence time (of implants). Hydrogels, some fluorinated and toughened via crosslinking, showed limited antifouling efficacy in the field, thought to be due to the adsorption of silt, probably a consequence of the soft nature of the coating.

Thus, there is a widespread need for nontoxic coatings that resist marine fouling.

### SUMMARY

Described herein are articles coated with one or more polyelectrolyte complexes. The polyelectrolyte complexes have a high glass transition temperature when the coating is contacted with an aqueous medium. In one aspect, the coating has a glass transition temperature of at least 45° C. when in contact with an aqueous medium, which makes the coatings described herein as “glassy.” The coating compositions described herein are effective in reducing adhesion of organisms on the surface of the coated article, which makes the coatings an effective antifouling coating.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims. In addition, all optional and preferred features and modifications of the described embodiments are usable in all aspects of the disclosure taught herein. Furthermore, the individual features of the dependent claims, as well as all optional and preferred features and modifications of the described embodiments are combinable and interchangeable with one another.

### BRIEF DESCRIPTION OF THE DRAWINGS

Many aspects of the present disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 shows film thickness as a function of the number of deposited layers for PEMUs. PDADMA/SPEEK (●); PMAPTA/SPEEK (Δ): and PVBT/SPEEK (□) deposited from 0.3 M LiCl at room temperature. All three systems grow linearly. Error bars are about the size of the data points.

FIG. 2 shows zeta potential measurements during the layer-by-layer buildup of PDADMA/SPEEK in 0.3 M NaCl at room temperature. Each data point represents an average of 3 measurements under 3.5 ml s⁻¹ flow using 1 mM NaCl as streaming electrolyte.

FIG. 3 shows atomic force microscopy images of 10-bilayer PEMUs on Si wafer showing surface topology and roughness. A, PDADMA/SPEEK with surface roughness, Rₐ, of 3.0 nm. B, PMAPTA/SPEEK, Rₐ=4.5 nm. C, PVBT/SPEEK, Rₐ=4.1 nm.

FIGS. 4A-4C show linear viscoelastic response of SPEEK complexes. Storage modulus G′ (○), loss modulus G″ (Δ) in Pa; and tan δ (⋄) for A), PVBT/SPEEK (35 wt % water); B), PMAPTA/SPEEK (25 wt % water); C), PDADMA/SPEEK (14 wt % water) during a cooling ramp while immersed in 0.01 M LiCl. 8 mm diameter tablets. 1 N axial strain was applied at a frequency of 0.1 Hz and a ramp rate of 2° C. min⁻¹

FIGS. 5A-5D show in-situ optical microscopy images of algae on bare glass, (A) before, (B) after flow, revealing persistent fouling; and on glass coated with 10 layers PDADMA/SPEEK of thickness ˜40 nm, C) before, and (D) after the minimum applied flow rate (0.8 cm s⁻¹) showing complete detachment of algae at room temperature. Scale bar is 100 μm.

FIG. 6 shows the profile of algae detachment under increasing flow rate at room temperature from uncoated glass (control) (⋅); PMAPTA/SPEEK (unmodified) (⋄); PMAPTA/SPEEK (modified) (♦); PDADMA/SPEEK (Δ); PVBT/PSS (○); PVBT/SPEEK (□).

FIGS. 7A-7B show the summary of the population of algae adhered to PEMUs on glass terminated with, (A, polyanions, and panel B, polycations) shown here as density before and after 14 cm s⁻¹ flow and percentage removal. Data with ˜100% removal was obtained in under 3 s while others were reported after 20 h under similar flow conditions. Data was averaged from 10 repeated individual experiments.

FIGS. 8A-8D shows rheology data when a polyelectrolyte complex is exposed to mixtures of water and formamide. A, PDADMA/PSS in 100% water; B, PDADMA/PSS in 75% water, 25% formamide; C, PVBTA/PSS in 100% water; D, PVBTA/PSS in 50% formamide, 50% water.

### DETAILED DESCRIPTION

Many modifications and other embodiments disclosed herein will come to mind to one skilled in the art to which the disclosed compositions and methods pertain having the benefit of the teachings presented in the foregoing descriptions and the associated drawings. Therefore, it is to be understood that the disclosures are not to be limited to the specific embodiments disclosed and that modifications and other embodiments are intended to be included within the scope of the appended claims. The skilled artisan will recognize many variants and adaptations of the aspects described herein. These variants and adaptations are intended to be included in the teachings of this disclosure and to be encompassed by the claims herein.

Although specific terms are employed herein, they are used in a generic and descriptive sense only and not for purposes of limitation.

As will be apparent to those of skill in the art upon reading this disclosure, each of the individual embodiments described and illustrated herein has discrete components and features which may be readily separated from or combined with the features of any of the other several embodiments without departing from the scope or spirit of the present disclosure.

Any recited method can be carried out in the order of events recited or in any other order that is logically possible. That is, unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is no way intended that an order be inferred, in any respect. This holds for any possible non-express basis for interpretation, including matters of logic with respect to arrangement of steps or operational flow, plain meaning derived from grammatical organization or punctuation, or the number or type of aspects described in the specification.

All publications mentioned herein are incorporated herein by reference to disclose and describe the methods and/or materials in connection with which the publications are cited. The publications discussed herein are provided solely for their disclosure prior to the filing date of the present application. Nothing herein is to be construed as an admission that the present invention is not entitled to antedate such publication by virtue of prior invention. Further, the dates of publication provided herein can be different from the actual publication dates, which can require independent confirmation.

While aspects of the present disclosure can be described and claimed in a particular statutory class, such as the system statutory class, this is for convenience only and one of skill in the art will understand that each aspect of the present disclosure can be described and claimed in any statutory class.

It is also to be understood that the terminology used herein is for the purpose of describing particular aspects only and is not intended to be limiting. Unless defined otherwise, all technical and scientific terms used herein have the same meaning as commonly understood by one of ordinary skill in the art to which the disclosed compositions and methods belong. It will be further understood that terms, such as those defined in commonly used dictionaries, should be interpreted as having a meaning that is consistent with their meaning in the context of the specification and relevant art and should not be interpreted in an idealized or overly formal sense unless expressly defined herein.

Prior to describing the various aspects of the present disclosure, the following definitions are provided and should be used unless otherwise indicated. Additional terms may be defined elsewhere in the present disclosure.

### Definitions

As used herein, “comprising” is to be interpreted as specifying the presence of the stated features, integers, steps, or components as referred to, but does not preclude the presence or addition of one or more features, integers, steps, or components, or groups thereof. Moreover, each of the terms “by”, “comprising,” “comprises”, “comprised of,” “including,” “includes,” “included,” “involving,” “involves,” “involved,” and “such as” are used in their open, non-limiting sense and may be used interchangeably. Further, the term “comprising” is intended to include examples and aspects encompassed by the terms “consisting essentially of” and “consisting of.” Similarly, the term “consisting essentially of” is intended to include examples encompassed by the term “consisting of.

As used in the specification and the appended claims, the singular forms “a,” “an” and “the” include plural referents unless the context clearly dictates otherwise. Thus, for example, reference to “a solvent” include, but are not limited to, mixtures or combinations of two or more such solvents, and the like.

It should be noted that ratios, concentrations, amounts, and other numerical data can be expressed herein in a range format. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. Ranges can be expressed herein as from “about” one particular value, and/or to “about” another particular value. Similarly, when values are expressed as approximations, by use of the antecedent “about,” it will be understood that the particular value forms a further aspect. For example, if the value “about 10” is disclosed, then “10” is also disclosed.

When a range is expressed, a further aspect includes from the one particular value and/or to the other particular value. For example, where the stated range includes one or both of the limits, ranges excluding either or both of those included limits are also included in the disclosure, e.g. the phrase “x to y” includes the range from ‘x’ to ‘y’ as well as the range greater than ‘x’ and less than ‘y’. The range can also be expressed as an upper limit, e.g. ‘about x, y, z, or less’ and should be interpreted to include the specific ranges of ‘about x’, ‘about y’, and ‘about z’ as well as the ranges of ‘less than x’, less than y′, and ‘less than z’. Likewise, the phrase ‘about x, y, z, or greater’ should be interpreted to include the specific ranges of ‘about x’, ‘about y’, and ‘about z’ as well as the ranges of ‘greater than x’, greater than y′, and ‘greater than z’. In addition, the phrase “about ‘x’ to ‘y’”, where ‘x’ and ‘y’ are numerical values, includes “about ‘x’ to about ‘y’”.

It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a numerical range of “about 0.1% to 5%” should be interpreted to include not only the explicitly recited values of about 0.1% to about 5%, but also include individual values (e.g., about 1%, about 2%, about 3%, and about 4%) and the sub-ranges (e.g., about 0.5% to about 1.1%; about 5% to about 2.4%; about 0.5% to about 3.2%, and about 0.5% to about 4.4%, and other possible sub-ranges) within the indicated range.

As used herein, the terms “about,” “approximate,” “at or about,” and “substantially” mean that the amount or value in question can be the exact value or a value that provides equivalent results or effects as recited in the claims or taught herein. That is, it is understood that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art such that equivalent results or effects are obtained. In some circumstances, the value that provides equivalent results or effects cannot be reasonably determined. In such cases, it is generally understood, as used herein, that “about” and “at or about” mean the nominal value indicated ±10% variation unless otherwise indicated or inferred. In general, an amount, size, formulation, parameter or other quantity or characteristic is “about,” “approximate,” or “at or about” whether or not expressly stated to be such. It is understood that where “about,” “approximate,” or “at or about” is used before a quantitative value, the parameter also includes the specific quantitative value itself, unless specifically stated otherwise.

As used herein, the term “substituted” is contemplated to include all permissible substituents of organic compounds. In a broad aspect, the permissible substituents include acyclic and cyclic, branched and unbranched, carbocyclic and heterocyclic, and aromatic and nonaromatic substituents of organic compounds. Illustrative substituents include, for example, those described below. The permissible substituents can be one or more and the same or different for appropriate organic compounds. For purposes of this disclosure, the heteroatoms, such as nitrogen, can have hydrogen substituents and/or any permissible substituents of organic compounds described herein which satisfy the valences of the heteroatoms. This disclosure is not intended to be limited in any manner by the permissible substituents of organic compounds. Also, the terms “substitution” or “substituted with” include the implicit proviso that such substitution is in accordance with permitted valence of the substituted atom and the substituent, and that the substitution results in a stable compound, e.g., a compound that does not spontaneously undergo transformation such as by rearrangement, cyclization, elimination, etc. It is also contemplated that, in certain aspects, unless expressly indicated to the contrary, individual substituents can be further optionally substituted (i.e., further substituted or unsubstituted).

The term “alkyl” as used herein is a branched or unbranched saturated hydrocarbon group of 1 to 24 carbon atoms, such as methyl, ethyl, n-propyl, isopropyl, n-butyl, isobutyl, s-butyl, t-butyl, n-pentyl, isopentyl, s-pentyl, neopentyl, hexyl, heptyl, octyl, nonyl, decyl, dodecyl, tetradecyl, hexadecyl, eicosyl, tetracosyl, and the like. The alkyl group can be cyclic or acyclic. The alkyl group can be branched or unbranched. The alkyl group can also be substituted or unsubstituted. For example, the alkyl group can be substituted with one or more groups including, but not limited to, alkyl, cycloalkyl, alkoxy, amino, ether, halide, hydroxy, nitro, silyl, sulfo-oxo, or thiol, as described herein. A “lower alkyl” group is an alkyl group containing from one to six (e.g., from one to four) carbon atoms. The term alkyl group can also be a C1 alkyl, C1-C2 alkyl, C1-C3 alkyl, C1-C4 alkyl, C1-C5 alkyl, C1-C6 alkyl, C1-C7 alkyl, C1-C8 alkyl, C1-C9 alkyl, C1-C10 alkyl, and the like up to and including a C1-C24 alkyl.

Throughout the specification “alkyl” is generally used to refer to both unsubstituted alkyl groups and substituted alkyl groups; however, substituted alkyl groups are also specifically referred to herein by identifying the specific substituent(s) on the alkyl group. For example, the term “halogenated alkyl” or “haloalkyl” specifically refers to an alkyl group that is substituted with one or more halide, e.g., fluorine, chlorine, bromine, or iodine. Alternatively, the term “monohaloalkyl” specifically refers to an alkyl group that is substituted with a single halide, e.g. fluorine, chlorine, bromine, or iodine. The term “polyhaloalkyl” specifically refers to an alkyl group that is independently substituted with two or more halides, i.e. each halide substituent need not be the same halide as another halide substituent, nor do the multiple instances of a halide substituent need to be on the same carbon. The term “alkoxyalkyl” specifically refers to an alkyl group that is substituted with one or more alkoxy groups, as described below. The term “aminoalkyl” specifically refers to an alkyl group that is substituted with one or more amino groups. The term “hydroxyalkyl” specifically refers to an alkyl group that is substituted with one or more hydroxy groups. When “alkyl” is used in one instance and a specific term such as “hydroxyalkyl” is used in another, it is not meant to imply that the term “alkyl” does not also refer to specific terms such as “hydroxyalkyl” and the like.

The term “cycloalkyl” as used herein is a non-aromatic carbon-based ring composed of at least three carbon atoms. Examples of cycloalkyl groups include, but are not limited to, cyclopropyl, cyclobutyl, cyclopentyl, cyclohexyl, norbornyl, and the like. The term “heterocycloalkyl” is a type of cycloalkyl group as defined above, and is included within the meaning of the term “cycloalkyl,” where at least one of the carbon atoms of the ring is replaced with a heteroatom such as, but not limited to, nitrogen, oxygen, sulfur, or phosphorus. The cycloalkyl group and heterocycloalkyl group can be substituted or unsubstituted. The cycloalkyl group and heterocycloalkyl group can be substituted with one or more groups including, but not limited to, alkyl, cycloalkyl, alkoxy, amino, ether, halide, hydroxy, nitro, silyl, sulfo-oxo, or thiol as described herein. In one aspect, the heterocycloalkyl group can be a lactam, including but not limited to an N-substituted lactam.

The term “aryl” as used herein is a group that contains any carbon-based aromatic group including, but not limited to, benzene, naphthalene, phenyl, biphenyl, anthracene, and the like. The aryl group can be substituted or unsubstituted. In one aspect, the aryl group can be substituted with one or more alkyl groups as defined herein.

The term “biaryl” is a specific type of aryl group and is included in the definition of “aryl.” In addition, the aryl group can be a single ring structure or comprise multiple ring structures that are either fused ring structures or attached via one or more bridging groups such as a carbon-carbon bond. For example, biaryl to two aryl groups that are bound together via a fused ring structure, as in naphthalene, or are attached via one or more carbon-carbon bonds, as in biphenyl. Fused aryl groups including, but not limited to, indene and naphthalene groups are also contemplated.

The term “heteroaryl” as used herein refers to an aryl group that has at least one heteroatom incorporated within the ring of the aromatic group. Examples of heteroatoms include, but are not limited to, nitrogen, oxygen, sulfur, and phosphorus, where N-oxides, sulfur oxides, and dioxides are permissible heteroatom substitutions. The heteroaryl group can be substituted or unsubstituted. Heteroaryl groups can be monocyclic, or alternatively fused ring systems. Heteroaryl groups include, but are not limited to, furyl, imidazolyl, pyrimidinyl, tetrazolyl, thienyl, pyridinyl, pyrrolyl, N-methylpyrrolyl, quinolinyl, isoquinolinyl, pyrazolyl, triazolyl, thiazolyl, oxazolyl, isoxazolyl, oxadiazolyl, thiadiazolyl, isothiazolyl, pyridazinyl, pyrazinyl, benzofuranyl, benzodioxolyl, benzothiophenyl, indolyl, indazolyl, benzimidazolyl, imidazopyridinyl, pyrazolopyridinyl, and pyrazolopyrimidinyl. Further not limiting examples of heteroaryl groups include, but are not limited to, pyridinyl, pyridazinyl, pyrimidinyl, pyrazinyl, thiophenyl, pyrazolyl, imidazolyl, benzo[d]oxazolyl, benzo[d]thiazolyl, quinolinyl, quinazolinyl, indazolyl, imidazo[1,2-b]pyridazinyl, imidazo[1,2-a]pyrazinyl, benzo[c][1,2,5]thiadiazolyl, benzo[c][1,2,5]oxadiazolyl, and pyrido[2,3-b]pyrazinyl.

The term “halide,” as used herein can be used interchangeably and refer to F;, Cl, Br, or I.

The term “molecular weight” is used herein to refer to the average molecular mass of an ensemble of synthetic polymers that contains a distribution of molecular masses. Unless otherwise noted, values reported herein are weight-average molecular weight (Mw).

The term “polyelectrolyte polymer” as used herein is defined as a polymer with ionized functional groups, where the ionized functional groups can be incorporated in the polymer backbone, a sidechain of the polymer, or a combination thereof. The polyelectrolyte also includes a counterion (i.e., cation or anion) depending upon the ionized functional group present on the polyelectrolyte.

The term “negatively charged polyelectrolyte polymer” as used herein is defined as a polymer with anionic functional groups, where the anionic functional groups can be incorporated in the polymer backbone, a sidechain of the polymer, or a combination thereof. The negatively charged polyelectrolyte polymer also includes a counterion (i.e., cation). Examples of cations include alkali metal ions, alkali earth metal ions, transitional metal ions, or quaternary ammonium ions. In one aspect, the negatively charged polyelectrolyte polymer” is produced when a polyanionic salt is dissolved in water.

The term “positively charged polyelectrolyte polymer” as used herein is defined as a polymer with cationic functional groups, where the cationic functional groups can be incorporated in the polymer backbone, a sidechain of the polymer, or a combination thereof. The positively charged polyelectrolyte polymer also includes a counterion (i.e., anion). Examples of anions include halides, carboxylates, sulfonate, or phosphates. In one aspect, the positively charged polyelectrolyte polymer” is produced when a polycationic salt is dissolved in water.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; and the number or type of embodiments described in the specification.

Disclosed are the components to be used to conduct the methods of the invention as well as the compositions themselves to be used within the methods disclosed herein. These and other materials are disclosed herein, and it is understood that when combinations, subsets, interactions, groups, etc. of these materials are disclosed that while specific reference of each various individual and collective combinations and permutation of these compounds cannot be explicitly disclosed, each is specifically contemplated and described herein. For example, if a particular compound is disclosed and discussed and a number of modifications that can be made to a number of molecules including the compounds are discussed, specifically contemplated is each and every combination and permutation of the compound and the modifications that are possible unless specifically indicated to the contrary. Thus, if a class of molecules A, B, and C are disclosed as well as a class of molecules D, E, and F and an example of a combination molecule, A-D is disclosed, then even if each is not individually recited each is individually and collectively contemplated meaning combinations, A-E, A-F, B-D, B-E, B-F, C-D, C-E, and C-F are considered disclosed. Likewise, any subset or combination of these is also disclosed. Thus, for example, the sub-group of A-E, B-F, and C-E would be considered disclosed. This concept applies to all aspects of this application including, but not limited to, steps in methods of making and using the compositions of the invention. Thus, if there are a variety of additional steps that can be performed it is understood that each of these additional steps can be performed with any specific embodiment or combination of embodiments of the methods of the invention.

As used herein, the terms “optional” or “optionally” means that the subsequently described event or circumstance can or cannot occur, and that the description includes instances where said event or circumstance occurs and instances where it does not.

Unless otherwise specified, temperatures referred to herein are based on atmospheric pressure (i.e. one atmosphere).

Described herein are articles coated with one or more polyelectrolyte complexes. The polyelectrolyte complexes have a high glass transition temperature when the coating is contacted with an aqueous medium. In one aspect, the coating has a glass transition temperature of at least 45° C. when in contact with an aqueous medium, which makes the coatings described herein as “glassy” at any temperature below 45° C. The coating compositions described herein are effective in reducing adhesion of organisms on the surface of the coated article, which makes the coatings an effective antifouling coating.

In general, the polyelectrolyte complex is formed by combining a predominantly negatively charged polyelectrolyte and a predominantly positively charged polyelectrolyte. In one aspect, the formation of the polyelectrolyte complex starts with combining separate solutions, each containing one of the polyelectrolytes. In this aspect, at least one solution comprises at least one predominantly positively-charged polyelectrolyte, and at least one solution comprises at least one predominantly negatively-charged polyelectrolyte. The formation of a polyelectrolyte complex, Pol⁺Pol⁻, by mixing individual solutions of the polyelectrolytes in their respective salt forms, Pol⁺A⁻ and Pol⁻M⁺, may be represented by the following equation:

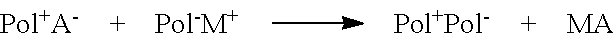

where M⁺ is a salt cation, such as sodium, and A⁻ is a salt anion such as chloride. Pol⁻ and Pol⁺ represent repeat units on predominantly negatively charged and predominantly positively charged polyelectrolytes, respectively. According to the equation, the process of complexation releases salt ions into external solution, which are then part of the salt solution concentration.

The precipitates of polyelectrolyte complex, Pol⁺Pol⁻, formed by the reaction above are usually loose with much entrained water. The as-precipitated complex may be rinsed with water to remove salt ions.

Separate solutions containing the polyelectrolytes are combined in a manner that allows the positively-charged polyelectrolyte(s) and the negatively-charged polyelectrolyte(s) to intermix. Intermixing the respective polyelectrolytes causes the in situ formation of a polyelectrolyte complex comprising an intermolecular blend of the positively-charged polyelectrolyte and the negatively-charged polyelectrolyte.

Individual polyelectrolyte solutions that are mixed may themselves comprise mixtures of polyelectrolytes of different chemical composition and/or molecular weight. For example, a solution may comprise two positive polyelectrolytes with two distinct chemical compositions. When the mixture of positive polyelectrolytes is mixed with the negative polyelectrolyte solutions the resulting complex will incorporate a blend of the two positive polyelectrolytes.

### Polyelectrolytes

The charged polymers (i.e., polyelectrolytes) used to form the polyelectrolyte complexes are water and/or organic soluble and comprise one or more monomer repeat units that are positively or negatively charged. The polyelectrolytes used herein may be copolymers that have a combination of charged and/or neutral monomers (e.g., positive and neutral; negative and neutral; positive and negative; or positive, negative, and neutral). Regardless of the exact combination of charged and neutral monomers, a polyelectrolyte of the present invention is predominantly positively charged or predominantly negatively charged and hereinafter is referred to as a “positively charged polyelectrolyte polymer” or a “negatively charged polyelectrolyte polymer,” respectively.

In one aspect, the polyelectrolytes can be described in terms of the average charge per repeat unit in a polymer chain, which is also referred to herein as charge density. For example, a copolymer composed of 100 neutral and 300 positively charged repeat units has an average charge of 0.75 (3 out of 4 units, on average, are positively charged). As another example, a copolymer that has 100 neutral, 100 negatively charged, and 300 positively charged repeat units would have an average charge of 0.4 (100 negatively charged units cancel 100 positively charged units leaving 200 positively charged units out of a total of 500 units). Thus, a positively-charged polyelectrolyte has an average charge per repeat unit between 0 and 1 and a negatively-charged polyelectrolyte has an average charge per repeat unit between 0 and −1. An example of a positively-charged copolymer is PDADMA-co-PAC (i.e., poly(diallyldimethylammonium chloride) and polyacrylamide copolymer) in which the PDADMA units have a charge of 1 and the PAC units are neutral so the average charge per repeat unit is less than 1. In one aspect, the positively-charged polyelectrolyte and the negatively-charged polyelectrolyte has an average positive or negative charge per repeat unit of about 0.1 to 2.0, or 0.1, 0.2, 0.3, 0.4, 0.5, 0.6, 0.7, 0.8, 0.9, 1.0, 1.2, 1.4, 1.6, 1.8, or 2.0 where any value can be a lower and upper endpoint of a range (e.g., 0.2 to 1.2). An average charge per repeat unit of 2 means there are two charges per repeat unit.

In one aspect, the coating has a net negative surface charge. In this aspect, the polyelectrolyte complex has a net negative charge. In one aspect, the coating has a net negative charge density greater than zero to about 10%, where the charge density of the negatively charged polyelectrolyte polymer is greater than the charge density of the positively charged polyelectrolyte polymer. A charge density of 100% means there is a full monolayer of charge density on the surface. In one aspect, the coating has a net negative charge density greater than zero, 1%, 2%, 3%, 4%, 5%, 6%, 7%, 8%, 9%, or 10%, where any value can be a lower and upper endpoint of a range (e.g., 2% to 8%). In another aspect, the coating has a net negative surface charge density from about 0.1×10⁻¹¹ moles of charges per cm² to 5×10⁻¹¹ moles of charges per cm².

In one aspect, the polyelectrolytes used herein include equal numbers of positive repeat units and negative repeat units distributed throughout the polymer in a random, alternating, or block sequence. These polyelectrolytes are termed “amphiphilic” polyelectrolytes. For examples, a polyelectrolyte may include 100 randomly distributed styrene sulfonate repeat units (negative) and 100 diallyldimethylammonium chloride repeat units (positive), said molecule having a net charge of zero. These amphiphilic polyelectrolytes also mix on the molecular level and are suitable for this invention. In one aspect, amphiphilic polyelectrolytes used herein include equal numbers of positive and negative repeat units.

In another aspect, the polyelectrolytes include a repeat unit that has both a negative and positive charge. Such repeat units are termed “zwitterionic” and the polyelectrolyte is termed a “zwitterionic polyelectrolyte.” Though zwitterionic repeat units contribute equal number of positive and negative repeat units, the zwitterionic group is still solvated and relatively hydrophilic. An example of a zwitterionic repeat unit is 3-[2-(acrylamido)-ethyldimethyl ammonio] propane sulfonate, AEDAPS. Zwitterionic groups are present on polyelectrolytes as blocks or randomly dispersed throughout the polymer chain. In one aspect, the polyelectrolytes include between about 1% and about 90% zwitterion units, and more preferably said polyelectrolyte comprises between about 10% and about 70% zwitterionic units. In other aspects, the polyelectrolytes having zwitterionic repeat units also include between about 10% and about 90% non-zwitterionic charged repeat units.

The charges on a polyelectrolyte may be derived directly from the monomer units used to make the polyelectrolyte, or they may be introduced by chemical reactions on a precursor polymer. For example, PDADMA is made by polymerizing diallyldimethylammonium chloride, a positively charged water soluble vinyl monomer. PDADMA-co-PAC is made by the polymerization of a mixture of diallyldimethylammonium chloride and acrylamide (a neutral monomer which remains neutral in the polymer). Poly(styrenesulfonic acid) is often made by the sulfonation of neutral polystyrene. Poly(styrenesulfonic acid) can also be made by polymerizing the negatively charged styrene sulfonate monomer. The chemical modification of precursor polymers to produce charged polymers may be incomplete and typically result in an average charge per repeat unit that is less than 1. For example, if only about 80% of the styrene repeat units of polystyrene are sulfonated, the resulting poly(styrenesulfonic acid) has an average charge per repeat unit of about −0.8.

In one aspect, the negatively charged polyelectrolyte polymer comprises a plurality of sulfonate groups, carboxylate groups, phosphate groups, phosphonate groups, or any combination thereof covalently bonded to the negatively charged polyelectrolyte polymer. In one aspect, the negatively charged polyelectrolyte polymer comprises a plurality of aryl groups, where one or more groups comprise an anionic group such as a sulfonate group, carboxylate group, phosphate group, phosphonate group, or any combination thereof.

In one aspect, the negatively charged polyelectrolyte polymer comprises a hydrocarbon backbone and one or more aryl groups pendant to the backbone, wherein each aryl group comprises at least one anionic group. In this aspect, the hydrocarbon backbone is produced by the polymerization of two or more different olefinic monomers, where the resulting polymers has a backbone composed primarily of carbon atoms. Depending upon the selection of the monomers, one or more aryl groups are covalently attached (i.e., pendant) to the hydrocarbon backbone. An example of this type of negatively charged polyelectrolyte polymer is poly(styrenesulfonic acid) (PSS).

In one aspect, the negatively charged polyelectrolyte polymer comprises backbone with one or more aryl groups, wherein each aryl group comprises at least one anionic group. An example of this negatively charged polyelectrolyte polymer sulfonated poly (ether ether ketone) (SPEEK). Other examples are provided in Table 1 below.

In one aspect, the negatively charged polyelectrolyte polymer comprises a sulfonated polyparaphenylene, a sulfonated polyetherether ketone, a sulfonated polysulfone, a sulfonated polyarylene, or a sulfonated polyarylene sulfone.

Exemplary negatively charged repeat units of the negatively charged polyelectrolyte polymer are shown in Table 1 (counterions not shown).

TABLE 1
Negatively Charged Repeat Unit

| Name | Structure |
|---|---|
| Sulfonated polyalphamethyl styrene | 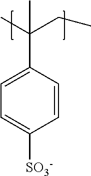 |
| styrenesulfonate (PSS) | 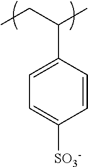 |
| Sulfonated polypropylene oxide | 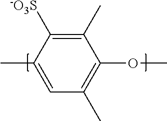 |
| Sulfonated polyetheretherketone (SPEEK) | 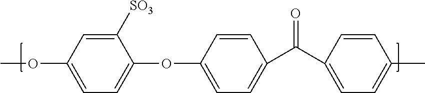 |
| Sulfonated polyphenylene sulfide | 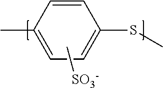 |
| Sulfonated polyparaphenylene | 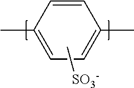 |
| Sulfonated polysulfone | 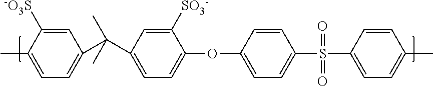 |

Examples of a negatively-charged synthetic polyelectrolyte include polyelectrolytes having a sulfonate group (—SO₃_{^{−}}), such as, for example, poly(styrenesulfonic acid) (PSS), poly(2-acrylamido-2-methyl-1-propane sulfonic acid) (PAMPS), sulfonated poly (ether ether ketone) (SPEEK), poly(ethylenesulfonic acid), poly(methacryloxyethylsulfonic acid), their salts, and copolymers thereof; polycarboxylates such as poly(acrylic acid) (PAA) and poly(methacrylic acid), polyphosphates, and polyphosphonates.

In one aspect, the positively charged polyelectrolyte polymer comprises a plurality of quaternary ammonium groups covalently bonded to the positively charged polyelectrolyte polymer. The term “quaternary ammonium group” is a group bearing a permanently positively charged nitrogen atom, as opposed to an amine, which may be protonated.

In one aspect, the quaternary ammonium group has the structure I

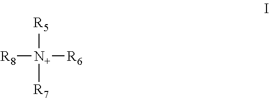

wherein R₅ is an aryl group or an alkylene group and is covalently bonded to the polymer backbone, and R₆, R₇ and R₈ are independently an alkyl group or an aryl group. In one aspect, R₆, R₇ and R₈ are each a C₁ to C₅ alkyl group. In another aspect, R₆, R₇ and R₈ are each a methyl group.

In one aspect, the quaternary ammonium group comprises a nitrogen-bearing heteroaryl group, wherein nitrogen is alkylated. For example, the heteroaryl group can be a pyridinium group such as a N-methylvinylpyridinium (MVP). In another aspect, the quaternary ammonium group comprises a nitrogen-bearing cycloalkyl group (e.g., a four- to seven-member ring), wherein nitrogen is alkylated. Non-limiting examples of these groups are provided in Table 2.

Exemplary positively charged repeat units of the positively charged polyelectrolyte polymer are shown in Table 2.

TABLE 2
Positively Charged Repeat Unit

| Name | Structure |
|---|---|
| diallyldimethylammonium (PDADMA) | 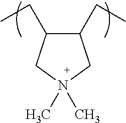 |
| N-methyl-2-vinyl pyridinium (PM2VP) | 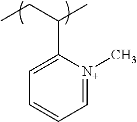 |
| N-methyl-4-vinylpyridinium (PM4VP) | 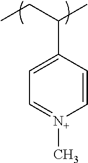 |
| N-octyl-4-vinylpyridinium (PNO4VP) | 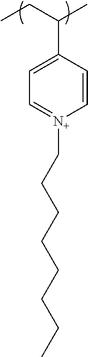 |
| N-methyl-2-vinyl pyridinium-co- ethyleneoxide (PM2VP-co-PEO) | 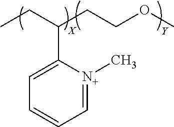 |
| | and Y denote proportions of repeat units |
| allylamine (PAH) | 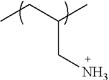 |

Examples of a positively-charged synthetic polyelectrolyte include polyelectrolytes having a quaternary ammonium group, such as poly(diallyldimethylammonium chloride) (PDADMA), poly(vinylbenzyltrimethylammonium) (PVBTA), ionenes, poly(acryloxyethyltrimethyl ammonium chloride), poly(methacryloxy(2-hydroxy)propyltrimethyl ammonium chloride), and copolymers thereof; polyelectrolytes comprising a pyridinium group such as poly(N-methylvinylpyridinium) (PMVP), including poly(N-methyl-2-vinylpyridinium) (PM2VP), other poly(N-alkylvinylpyridines), and copolymers thereof; protonated polyamines such as poly(allylaminehydrochloride) (PAH), polyvinylamine, polyethyleneimine (PEI); polysulfoniums, and polyphosphoniums.

Further examples of polyelectrolytes include charged biomacromolecules, which are naturally occurring polyelectrolytes, or synthetically modified charged derivatives of naturally occurring biomacromolecules, such as modified celluloses, chitosan, or guar gum. A positively-charged biomacromolecule usually comprises a protonated sub-unit (e.g., protonated amines). Some negatively charged biomacromolecules comprise a deprotonated sub-unit (e.g., deprotonated carboxylates or phosphates). Examples of biomacromolecules which may be charged for use in accordance with the present invention include proteins, polypeptides, enzymes, DNA, RNA, glycosaminoglycans, alginic acid, chitosan, chitosan sulfate, cellulose sulfate, polysaccharides, dextran sulfate, carrageenin, glycosaminoglycans, sulfonated lignin, and carboxymethylcellulose.

In one aspect, the molecular weight (number average) of synthetic polyelectrolyte molecules is typically about 1,000 to about 5,000,000 grams/mole, or about 10,000 grams/mole to about 1,000,000 grams/mole, or 10,000 grams/mole, 50,000 grams/mole, 100,000 grams/mole, 150,000 grams/mole, 200,000 grams/mole, 250,000 grams/mole, 300,000 grams/mole, 350,000 grams/mole, 400,000 grams/mole, 450,000 grams/mole, 500,000 grams/mole, 550,000 grams/mole, 600,000 grams/mole, 650,000 grams/mole, 700,000 grams/mole, 750,000 grams/mole, 800,000 grams/mole, 850,000 grams/mole, 900,000 grams/mole, 950,000 grams/mole, or 1,000,000 grams/mole, where any value can be a lower or upper endpoint of a range (e.g., 450,000 grams/mole to 800,000 grams/mole). The molecular weight of naturally occurring polyelectrolyte molecules (i.e., biomacromolecules), however, can reach as high as 10,000,000 grams/mole.

Many of the polyelectrolytes useful herein, such as PDADMA and PEI, exhibit some degree of branching. Branching may occur at random or at regular locations along the backbone of the polymer. Branching may also occur from a central point and in such a case the polymer is referred to as a “star” polymer, if generally linear strands of polymer emanate from the central point. If, however, branching continues to propagate away from the central point, the polymer is referred to as a “dendritic” polymer. Branched polyelectrolytes, including star polymers, comb polymers, graft polymers, and dendritic polymers, are also suitable for purposes of this invention. Block polyelectrolytes, wherein a macromolecule comprises at least one block of charged repeat units, are also suitable. In one aspect, the number of blocks may be 2 to 5, preferably 2 or 3. In one aspect, if the number of blocks is 3 the block arrangement is ABA.

Many of the foregoing polyelectrolytes have very low toxicity. For example, poly(diallyldimethylammonium chloride), poly(2-acrylamido-2-methyl-1-propane sulfonic acid) and their copolymers are used in the personal care industry, e.g., in shampoos. Also, because some of the polyelectrolytes used in the method of the present invention are synthetic or synthetically modified natural polymers, their properties (e.g., charge density, viscosity, water solubility, and response to pH) may be tailored by adjusting their composition.

Polyelectrolyte solutions used to produce the polyelectrolyte complexes include a solvent. An appropriate solvent is one in which the selected polyelectrolyte is soluble. Thus, the appropriate solvent is dependent upon whether the polyelectrolyte is considered to be hydrophobic or hydrophilic. A hydrophobic polymer displays less favorable interaction energy with water than a hydrophilic polymer. While a hydrophilic polymer is water soluble, a hydrophobic polymer may only be sparingly soluble in water, or, more likely, insoluble in water. Likewise, a hydrophobic polymer is more likely to be soluble in organic solvents than a hydrophilic polymer.

In general, the higher the carbon to charge ratio of the polymer, the more hydrophobic it tends to be. For example, polyvinyl pyridine alkylated with a methyl group (PNMVP) is considered to be hydrophilic, whereas polyvinyl pyridine alkylated with an octyl group (PNOVP) is considered to be hydrophobic. Thus, water is preferably used as the solvent for hydrophilic polyelectrolytes and organic solvents such as ethanol, methanol, dimethylformamide, acetonitrile, carbon tetrachloride, and methylene chloride are preferably used for hydrophobic polyelectrolytes. Even if polyelectrolyte complexes are prepared by mixing organic-soluble and water-soluble polymers, the complex is preferably rinsed to remove organic solvents before it is dried according to the method described herein. Some organic solvents are hard to remove even with extensive rinsing. Therefore, the preferred solvent for polyelectrolyte complexation is water.

Examples of polyelectrolytes that are soluble in water include, but are not limited to, poly(styrenesulfonic acid), poly(2-acrylamido-2-methyl-1-propane sulfonic acid), sulfonated lignin, poly(ethylenesulfonic acid), poly(methacryloxyethylsulfonic acid), poly(acrylic acids), poly(methacrylic acids), their salts, and copolymers thereof; as well as poly(diallyldimethylammonium chloride), poly(vinylbenzyltrimethylammonium), ionenes, poly(acryloxyethyltrimethyl ammonium chloride), poly(methacryloxy(2-hydroxy)propyltrimethyl ammonium chloride), and copolymers thereof; and polyelectrolytes comprising a pyridinium group, such as, poly(N-methylvinylpyridium), and protonated polyamines, such as, poly(allylamine hydrochloride), polyvinylamine and poly(ethyleneimine).

Some polyelectrolytes include rigid rod backbones, such as aromatic backbones, or partially aromatic backbones, including sulfonated polyparaphenylene, sulfonated polyetherether ketones (SPEEK), sulfonated polysulfones, sulfonated polyarylenes, sulfonated polyarylene sulfones, and polyarylenes comprising alkylammonium groups.

In certain aspects, the charged polyelectrolyte may be a synthetic copolymer comprising pH sensitive repeat units, pH insensitive repeat units, or a combination of pH sensitive repeat units and pH insensitive repeat units. pH insensitive repeat units maintain the same charge over the working pH range of use. The rationale behind such a mixture of pH sensitive groups and pH insensitive groups on the same molecule is that the pH insensitive groups interact with other, oppositely-charged pH insensitive groups on other polymers, holding the polyelectrolyte complex together despite the state of ionization of the pH sensitive groups.

For example, poly(acrylic acids) and derivatives begin to take on a negative charge within the range of about pH 4 to about 6 and are negatively charged at higher PH levels. Below this transition pH range, however, poly(acrylic acids) are protonated (i.e., uncharged). Similarly, polyamines and derivative thereof take on a positive charge if the pH of the solution is below their pKₐ. As such, and in accordance with the present invention, the pH of a polyelectrolyte solution may be adjusted by the addition of an acid and/or base in order to attain, maintain, and/or adjust the electrical charge of a polyelectrolyte at the surface of, or within, a polyelectrolyte complex.

The state of ionization, or average charge per repeat unit, for polyelectrolytes bearing pH sensitive groups depends on the pH of the solution. For example, a polyelectrolyte comprising 100 pH insensitive positively charged units, such as DADMA, and 30 pH sensitive negatively charged units, such as acrylic acid (AA), will have a net charge of +100 at low pH (where the AA units are neutral) and an average of +100/130 charge per repeat unit; and a net charge of +70 at high pH (where 30 ionized AA units cancel out 30 of the positive charges) and an average of +70/130 charge per repeat unit. The different monomer units may be arranged randomly along the polymer chain (“random” copolymer) or they may exist as blocks (“block” copolymer). The average charge per repeat unit is also known as the “charge density.”

pH sensitive polyelectrolyte complexes include pH sensitive polymeric repeat units including moieties such as, for example, carboxylates, pyridines, imidazoles, piperidines, phosphonates, primary, secondary and tertiary amines, and combinations thereof. In one aspect, the polyelectrolytes include copolymers comprising carboxylic acids, such as poly(acrylic acids), poly(methacrylic acids), poly(carboxylic acids), and copolymers thereof. Additional preferred polyelectrolytes comprise protonatable nitrogen atoms, such as poly(pyridines), poly(imidazoles), poly(piperidines), and poly(amines) bearing primary, secondary or tertiary amine groups, such as poly(vinylamines) and poly(allylamine).

To avoid disruption and possible decomposition of the polyelectrolyte complex, polyelectrolytes having pH sensitive repeat units additionally can include pH insensitive charged functionality on the same molecule. In one aspect, the pH insensitive repeat unit is a positively charged repeat unit selected from the group consisting of repeat units containing a quaternary nitrogen atom, a sulfonium (S⁺) atom, or a phosphonium atom. Thus, for example, the quaternary nitrogen may be part of a quaternary ammonium moiety (—N⁺RₐR_{b}R_{c} wherein Rₐ, R_{b}, and R_{c} are independently alkyl, aryl, or mixed alkyl and aryl), a pyridinium moiety, a bipyridinium moiety or an imidazolium moiety, the sulfonium atom may be part of a sulfonium moiety (—S⁺RₐRₑ wherein Rₐ and Rₑ are independently alkyl, aryl, or mixed alkyl and aryl) and the phosphonium atom may be part of a phosphonium moiety (—P⁺R_{f}R_{g}Rₕ wherein R_{f}, R_{g}, and Rₕ are independently alkyl, aryl, or mixed alkyl and aryl). In another embodiment, the pH insensitive repeat unit is a negatively charged repeat unit selected from the group consisting of repeat units containing a sulfonate (—SO₃_{^{−}}), a phosphate (—OPO₃_{^{−}}), or a sulfate (—SO₄_{^{−).}}

Exemplary negatively charged pH insensitive charged repeat units include styrenesulfonic acid, 2-acrylamido-2-methyl-1-propane sulfonic acid, sulfonated lignin, ethylenesulfonic acid, methacryloxyethylsulfonic acid, sulfonated ether ether ketone, phosphate. In one aspect, the pH insensitive negatively charged polyelectrolytes include polyelectrolytes having a sulfonate group (—SO₃_{^{−}}), such as poly(styrenesulfonic acid) (PSS), poly(2-acrylamido-2-methyl-1-propane sulfonic acid) (PAMPS), sulfonated poly (ether ether ketone) (SPEEK), sulfonated lignin, poly(ethylenesulfonic acid), poly(methacryloxyethylsulfonic acid), their salts, and copolymers thereof.

Exemplary positively charged pH insensitive repeat units include diallyldimethylammonium, vinylbenzyltrimethylammonium, vinylalkylammoniums, ionenes, acryloxyethyltrimethyl ammonium chloride, methacryloxy(2-hydroxy)propyltrimethyl ammonium, N-methylvinylpyridinium, other N-alkylvinyl pyridiniums, a N-aryl vinyl pyridinium, alkyl- or aryl imidazolium, sulfonium, or phosphonium. Preferred pH insensitive positively-charged polyelectrolytes comprising a quaternary ammonium group, such as poly(diallyldimethylammonium chloride) (PDADMA), poly(vinylbenzyltrimethylammonium) (PVBTA), poly(alkyammoniums), ionenes, poly(acryloxyethyltrimethyl ammonium chloride), poly(methacryloxy(2-hydroxy)propyltrimethyl ammonium chloride), and copolymers thereof; polyelectrolytes comprising a pyridinium group such as poly(N-methylvinylpyridinium) (PMVP), other poly(N-alkylvinylpyridines), and copolymers thereof.

The pH insensitive polyelectrolyte may include a repeat unit that contains protonatable functionality, wherein the functionality has a pKa outside the range of experimental use. For example, poly(allylamine) has protonatable amine functionality with pka in the range 8-10 and is fully charged (protonated) if the experimental conditions do not surpass a pH of about 7.

In one aspect, the pH insensitive groups constitute about 10 mol % to about 100 mol % of the repeat units of the polyelectrolyte, or about 10 mol %, 15 mol %, 20 mol %, 25 mol %, 30 mol %, 35 mol %, 40 mol %, 45 mol %, 50 mol %,55 mol %, 60 mol %, 65 mol %, 70 mol %, 75 mol %, 80 mol %, 90 mol %, 95 mol %, or 100 mol %, where any value can be a lower or upper endpoint of a range (e.g., 20 mol % to 80 mol %). In one aspect, the pH sensitive groups constitute about 30 mol % to about 70 mol % of the repeat units of the polyelectrolyte.

Optionally, the polyelectrolytes can include an uncharged repeat unit that is not pH sensitive in the operating pH range, for example, about pH 3 to about pH 9. Said uncharged repeat unit is preferably hydrophilic. Examples of uncharged hydrophilic repeat units include, but are not limited to, acrylamide, vinyl pyrrolidone, ethylene oxide, and vinyl caprolactam. The structures of these uncharged repeat units are shown in Table 3. In one aspect, uncharged repeat units also include N-isopropylacrylamide and propylene oxide.

TABLE 3
Neutral Repeat Units

| Name | Structure |
|---|---|
| Acrylamide | 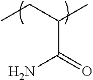 |
| Vinylpyrrolidone | 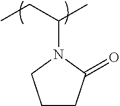 |
| Ethylene oxide | 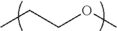 |
| Vinylcaprolactam | 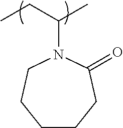 |

In one aspect, the polyelectrolytes include zwitterionic repeat units in the amount of about 10% and about 90% non-zwitterionic charged repeat units. Preferred zwitterionic repeat units are poly(3-[2-(acrylamido)-ethyldimethyl ammonio] propane sulfonate) (PAEDAPS) and poly(N-propane sulfonate-2-vinyl pyridine) (P2PSVP). Examples of other suitable zwitterionic groups are described in U.S. Pat. Pub. No. 20050287111, which is hereby incorporated by reference.

In one aspect, a chemical crosslinking is introduced into the polyelectrolyte complex for stability after formation. After formation an article may be treated with a difunctional crosslinking agent, such as XCH₂-φ-CH₂X, where X is a halogen (Cl, Br, or I) and φ is a phenyl group. The phenyl group may be replaced by another aromatic or aliphatic moiety, and easily-displaceable groups, such as toluene sulfonate, may replace the halogen. In one aspect, the crosslinking agent is a dihalogenated compound, such as an aromatic or aliphatic dibromide, which is able to alkylate residual unalkylated units on two adjoining polyelectrolyte chains.

In another aspect, the method of chemical crosslinking a polyelectrolyte complex is heat treatment. For example, amide crosslinks can be formed by heating polyelectrolytes having amine and carboxylic acid groups. In another aspect, a carbodiimide can be added to the polyelectrolytes to activate chemical crosslinking. The level of chemical crosslinking is between about 0.01% and about 50% as measured as a percentage of total ion pairs within the polyelectrolyte complex, or about 0.01%, 0.05%, 0.1%, 0.5%, 1%, 2%, 4%, 6%, 8%, 10%, 15%, 20%, 25%, 30%, 35%, 40%, 45%, or 50%, 8%, where any value can be a lower or upper endpoint of a range (e.g., 0.1% to 10%).

In another aspect, chemical crosslinking of a polyelectrolyte complex can be performed by photocrosslinking. Photocrosslinking may be achieved by the light-induced decomposition or transformation of functional groups, such as diarylbenzophenones, that form part of the polymer molecules. In another aspect, photocrosslinking of a polyelectrolyte complex may be accomplished by infusing the reformed polyelectrolyte complex with a small photoactive crosslinker molecule, such as diazidostilbene, then exposing the polyelectrolyte complex to light.

In other aspects, the polyelectrolyte complex includes further physical crosslinks created by hydrogen bonding. Hydrogen bonding is weaker than chemical bonding and occurs between a hydrogen bond donor and a hydrogen bond acceptor. Hydrogen bonds are minimally impacted by the presence of salt and thus the level of physical crosslinking due to hydrogen bonding remains substantially the same as the salt concentration is varied. Accordingly, the polyelectrolyte complex further comprises polymer repeat units capable of hydrogen bonding.

### Additives

Solid additives can be incorporated into the polyelectrolyte complex in order to modify the physical properties of the articles described herein The additives can include fillers and/or reinforcing agents and/or toughening agents, such as inorganic materials such as metal or semimetal oxide particles (e.g., silicon dioxide, aluminum oxide, titanium dioxide, iron oxide, zirconium oxide, and vanadium oxide), clay minerals (e.g., hectorite, kaolin, laponite, attapulgite, montmorillonite), hydroxyapatite or calcium carbonate.

In one aspect, high aspect ratio fillers can be used for stiffening or strengthening the articles described herein at a relatively low fill loading. Examples of high aspect ratio additives include, but are not limited to, metal fibers, inorganic platelets such as calcium carbonate or calcium phosphate (such as hydroxyapatite), needle-like clay minerals, such as attapulgite and halloysite, and carbon-based fibers such as carbon fibers or single or multiwalled carbon nanotubes or graphene. Other high aspect ratio materials having at least one dimension in the 1 nanometer to 100 micrometer range are suitable additives. Such high aspect ratio materials include polymer fibers, such as nylon, aramid, polyolefin, polyester, cotton, and cellulose fibers, as well as cellulose nanofibers. The weight % of additives in the polyelectrolyte complex article depends on many factors, such as the aspect ratio and the degree of modification of physical properties required. Accordingly, the solid additives may be between about 1 wt % to about 90 wt % of the polyelectrolyte complex article, or about 1 wt %, 5 wt %, 10 wt %, 15 wt %, 20 wt %, 25 wt %, 30 wt %, 35 wt %, 40 wt %, 45 wt %, 50 wt %, 55 wt %, 60 wt %, 65 wt %, 70 wt %, 75 wt %, 80 wt %, 85 wt %, or 90 wt %, where any value can be a lower or upper endpoint of a range (e.g., 10 wt % to 50 wt %).

In another aspect, the articles described herein can include magnetic particles having at least one dimension in the size range between 2 nanometers and 100 micrometers that can be manipulated with a magnetic field. For example, the articles described herein with the magnetic particles may be retrieved after use with a larger permanent magnet.

In one aspect, the additives are added prior to the preparation of the polyelectrolyte complex. For example, negatively charge additives can be combined with solutions composed of negatively charged polyelectrolytes prior to mixing with solutions composed of positively charged polyelectrolytes so that the additives and polyelectrolytes do not associate prematurely. In one aspect, the additive(s) and individual polyelectrolytes are thoroughly mixed in solution first under shear flow (as created by stirring or a homogenizer) with the proviso that the shear rate should not be sufficient to break up the polymer chains. In another aspect, if the polyelectrolyte stabilizes and assists in the dispersion of the additive it may be preferable to first mix additive and polyelectrolytes of opposite charge. For example, nanotubes can sometimes be dispersed better in solution if they are “wrapped” with polymers.

In one aspect, additives providing structural properties can be mixed with one of the constituent polyelectrolyte solutions that are used to prepare the polyelectrolyte complex. The advantage of introducing additives prior to the formation of the polyelectrolyte complex is that the additives are incorporated more uniformly throughout the polyelectrolyte complex.

In another aspect, a wide variety of salt ions may be added to the polyelectrolyte in solution or suspension of glassy PEC particles. In general, the salt may comprise any cation selected from among the alkali metal cations, alkaline earth metal cations, transition metal cations, semi-metallic cations, and organic cations such as amines or quaternary ammoniums. The salt(s) may comprise a mixture of two or more of any of these cations. Among the alkali metal cations, lithium, sodium, potassium, and rubidium, with sodium and potassium being particularly preferred. Among the alkaline earth metal cations, magnesium, calcium, strontium, and barium may be incorporated into the polyelectrolyte solution. Calcium and magnesium cations are particularly preferred, and for environmental applications, the choice of alkaline earth metal cations may be limited to calcium and magnesium. Other metal cations that may used in the polyelectrolyte solution are organic cations such as ammonium, primary, secondary, and tertiary amines, quaternary ammoniums comprising alkyl groups having from one to eight carbon atoms, and guanidinium and derivatives thereof. Primary amines, secondary amines, and tertiary amines are protonated to achieve positive charge and are thus pH sensitive. Exemplary primary amines, secondary amines, and tertiary amines are protonated forms of methylamine, dimethylamine, trimethyl amine, ethylamine, diethylamine, and triethylamine among others. Quaternary amines are pH insensitive groups. Exemplary quaternary amines include tetramethylammonium, tetraethylammonium, tetrapropylammonium, among others. In one embodiment, the amine is a linear polyamine such as ethylene diamine, diethylene triamine, dipropylene triamine, triethylene tetraamine, tripropylene tetraamine, tetraethylene pentaamine, tetrapropylene pentaamine, spermine, or spermidine.

The anion for the salt optionally added to the polyelectrolyte solution may be selected from among halide anions, oxoanions, and organic anions. A combination of anions may be used. Halide ions include fluoride, chloride, bromide, and iodide. Oxoanions include sulfonate, sulfate, sulfite, phosphate, phosphite, phosphonate, pyrophosphate, hypochlorite, chlorite, chlorate, iodate, periodate, bromate, borate, carbonate, nitrate, nitrate, aluminate, and manganate, among others. Organic anions include carboxylates, such as citrate, lactate, acetate, benzoate, formate, malate, malonate, fumarate, oxalate, propionate, butyrate, tartrate, and valerate, phthalate, among others. Organic solvent may optionally be added to the aqueous salt solution or suspension of glassy PEC particles.

Other preferred salts include chloride salts, citrate salts, and phosphate salts. Preferred chloride salts include sodium chloride, potassium chloride, magnesium chloride, calcium chloride, and aluminum chloride. Preferred citrate salts include trisodium citrate, disodium hydrogencitrate, sodium dihydrogencitrate, tripotassium citrate, dipotassium hydrogencitrate, potassium dihydrogencitrate, magnesium citrate, and calcium citrate. Preferred phosphate salts include trisodium phosphate, disodium hydrogen phosphate, sodium dihydrogen phosphate, tripotassium phosphate, dipotassium hydrogen phosphate, potassium dihydrogen phosphate, disodium potassium phosphate, sodium dipotassium phosphate, sodium potassium hydrogen phosphate, calcium phosphate, and magnesium phosphate. In another aspect, the additives include copper in metallic or salt or complexed form.

### Properties of the Polyelectrolyte Complex Coatings

The polyelectrolyte complexes described herein have a high glass transition temperature when in with an aqueous medium, which makes them suitable as antifouling agents in aquatic applications. In one aspect, the polyelectrolyte complexes have a glass transition temperature of at least 45° C. when in contact with an aqueous medium, at least 80° C. when in contact with an aqueous medium, or at least 90° C. when in contact with an aqueous medium. In another aspect, the polyelectrolyte complexes have a glass transition temperature of at least 45° C., 55° C., 65° C., 75° C., 85° C., 95° C., 105° C., 115° C., or 125° C. when in contact with an aqueous medium, where any value can be a lower and upper endpoint of a range (e.g., 55° C. to 85° C.).

When polyelectrolyte complexes in any morphology are exposed to aqueous environments, they are readily hydrated. In one aspect, the polyelectrolyte complexes in the coatings described herein have a degree of hydration of about 15 weight percent to about 50 weight percent when in contact with an aqueous medium. In another aspect, the polyelectrolyte complexes in the coatings described herein have a degree of hydration of about 15 weight percent, 20 weight percent, 25 weight percent, 30 weight percent, 35 weight percent, 40 weight percent, 45 weight percent, or 50 weight percent when in contact with an aqueous medium, where any value can be a lower and upper endpoint of a range (e.g., 20 weight percent to 35 weight percent).

### Preparation of Polyelectrolyte Complex Coatings

The coating composed of the polyelectrolyte complex described herein can be produced by a variety of methods. In one aspect, the coating is produced by the method comprising applying to the surface of an article a coating comprising a polyelectrolyte complex. In one aspect, a solution of at least one positively charged polyelectrolyte polymer and a solution of at least one negatively charged polyelectrolyte polymer are mixed with one another to produce the polyelectrolyte complex. In one aspect, the solutions are composed of water, an organic solvent, or a combination thereof. In one aspect, each polyelectrolyte solution is composed of about 0.01 wt % to about 50 wt % by weight of the polyelectrolyte (positive or negative), or about 0.10 wt %, 0.5 wt %, 1 wt %, 5 wt %, 10 wt %, 15 wt %, 20 wt %, 25 wt %, 30 wt %, 35 wt %, 40 wt %, 45 wt %, or 50 wt %, where any value can be a lower or upper endpoint of a range (e.g., 1 wt % to 20 wt %).

In another aspect, particles of the polyelectrolyte complex are first prepared as a suspension or slurry using the techniques described above. These particles of the glassy polyelectrolyte complex may be concentrated by being allowed to settle or by centrifuging or using other methods to dewater the slurry. The resulting concentrated suspension or slurry has a higher solids content and is preferred for coatings by painting a surface with a roller or brush. In one aspect, the solids content is between 1% and 80%, preferably between 5% and 80%.

In one aspect, the particle size of glassy polyelectrolyte complex comprising a suspension or slurry of polyelectrolyte complex is between 0.1 micrometers and 200 micrometers in average diameter, preferably between 1 micrometer and 50 micrometers in diameter.

In another aspect, the coating can be produced by sequentially applying to the surface of the article at least one negatively charged polyelectrolyte polymer composition and at least one positively charged polyelectrolyte polymer composition in a layer-by-layer approach. In one aspect, the coatings described herein can be applied to an article by applying alternating solutions comprising one or more positive and one or more negative polyelectrolytes. The article may be dipped or sprayed, with an optional rinse in solution containing no polyelectrolyte in between the polyelectrolyte exposures. In one aspect, to avoid a rinse step and loss/waste of polyelectrolyte solution, the sequential sprays of positive and negative polyelectrolyte solution are performed with precise dosing, such that exactly equal numbers of positive polymer repeat units and negative polymer repeat units, or a small excess of negative polymer repeat units, are sprayed sequentially or simultaneously on the article.

In other aspects, the article can be configured to include two or more different polyelectrolyte complexes. In one aspect, a first polyelectrolyte complex coating with a glass transition temperature of less than 45° C. when in contact with an aqueous medium is first applied to the surface of the article followed by applying a second polyelectrolyte complex coating with a glass transition temperature of at least 45° C. when in contact with an aqueous medium. In this aspect, the first polyelectrolyte complex coating is disposed between the surface of the article and the second polyelectrolyte complex coating.

The polyelectrolyte complex as a solution or slurry or the solutions of negatively charged polyelectrolyte polymer and positively charged polyelectrolyte polymer can be applied to an article using techniques known in the art depending upon the article to be coated and the amount of coating to be applied to the article. In one aspect, the coating can be applied by dipping, spraying, or painting the coating on the article. The thickness of the coating to be applied to the article can also vary. In one aspect, the coating has a thickness of about 10 nanometers to about 1 millimeter, preferably 10 nanometers to 1,000 micrometers, 10 nanometers to 500 micrometers, or 30 nanometers to 400 micrometers.

In one aspect, after the coating has been applied to the article, the coating is fused. In one aspect, the coated article is heated to fuse the coating. In one aspect, the coated article is heated at a temperature of about 100° C. to about 200° C. For example, water with one or more different organic solvents can be heated to produce steam that can be applied to the coated article. In another aspect, the coating can be applied at an elevated temperature and pressure such that fusing occurs when the coating is applied to the article.

In another aspect, formamide can be used to fuse the coating composed of the polyelectrolyte complex. Not wishing to be bound by theory, formamide lowers the glass transition temperature of the polyelectrolyte complex. As demonstrated in the Example, it has been unexpectedly discovered that polyelectrolyte complexes swollen with formamide have a significantly lower glass transition than the same polyelectrolyte complex swollen with water. Here, the polyelectrolyte complex particles with a lower glass transition temperature can flow and subsequently fuse with one another.

Depending upon how the polyelectrolyte complex is applied to the article, formamide can be incorporated in different ways. In one aspect, when the polyelectrolyte complex is applied to an article as a solution or slurry, formamide can be included in the solution or slurry. In one aspect, formamide is from 10 weight percent to about 50 weight percent of the solution or slurry. In one aspect, formamide is 10 weight percent, 10 weight percent, 15 weight percent, 20 weight percent, 25 weight percent, 30 weight percent, 35 weight percent, 40 weight percent, 45 weight percent, or 50 weight percent of the solution or slurry, where any value can be a lower and upper endpoint of a range (e.g., 15 weight percent to 35 weight percent).

In another aspect, formamide can be applied to the coating after the coating composed of the polyelectrolyte complex is applied to the surface of the article. In one aspect, the formamide is applied to the coating in an amount from about 10 weight percent to about 100 weight percent relative to the amount of the coating. In one aspect, formamide is 10 weight percent, 20 weight percent, 30 weight percent, 40 weight percent, 50 weight percent, 60 weight percent, 70 weight percent, 80 weight percent, 90 weight percent, or 100 weight percent relative to the amount of the coating, where any value can be a lower and upper endpoint of a range (e.g., 20 weight percent to 80 weight percent).

In the methods where formamide is used, after the resulting coated article can be rinsed with water to substantially (e.g., greater than 95%) or completely remove formamide from the article.

In certain aspect, after the coating has been applied to the article by solution/slurry or by layer-by-layer as discussed above, a negatively charged polyelectrolyte polymer can be applied to the coating. Not wishing to be bound by theory, a negatively charged surface has better antifouling properties.

### Applications of Coatings as Antifouling Agents

The coatings described herein are effective antifouling agents. Coatings that prevent or decrease fouling are sought for many applications, including those that inhibit the attachment of organisms in aquatic environments. Not wishing to be bound by theory, the coating described herein reduce the adhesion of organisms to a surface of an article that is exposed to an aqueous medium for extended periods of time. In one aspect, the organism can be a microorganism such as bacteria or algae. In another aspect, the organism can be barnacles and other organisms that live in sea water such as seaweed.

The coatings described herein can be applied to any number of articles where it is desirable to reduce or prevent the adhesion and growth of organisms on the surface of an article exposed to aqueous medium for extended periods of time. Examples of such articles include, but are not limited to, a hull of a nautical vessels, a pipe, a dock, a cable, a chain, a rope, a buoy, a weight, a propellor, or an anchor.

The Examples demonstrate the ability of the coating compositions described herein are effective in reducing the adhesion of organisms to a surface and, thus, effective as antifouling agents.

### Kits

Described herein are kits for producing and applying the coatings described herein to a surface of an article.

In one aspect, the kit comprises
(a) a mixture comprising at least one negatively charged polyelectrolyte polymer and at least one positively charged polyelectrolyte polymer; and
(b) formamide.

In one aspect, the kit comprises
(a) at least one negatively charged polyelectrolyte polymer;
(b) at least one positively charged polyelectrolyte polymer; and
(c) formamide.

In one aspect, the mixture comprising at least one negatively charged polyelectrolyte polymer and at least one positively charged polyelectrolyte polymer, is a dry powder. In another aspect, the mixture comprising at least one negatively charged polyelectrolyte polymer and at least one positively charged polyelectrolyte polymer is in a solvent such as, for example, water. Thus, the kits can optionally include a solvent (e.g., water, organic solvent, or a combination thereof.

The kits can optionally include an applicator for applying the at least one negatively charged polyelectrolyte polymer and at least one positively charged polyelectrolyte polymer in a layer-by-layer approach, the polyelectrolyte complex as a solution or slurry, and the formamide.

### ASPECTS

Aspect 1. An article comprising a coating for reducing fouling on a surface of an article, wherein the coating comprises a polyelectrolyte complex comprising at least one negatively charged polyelectrolyte polymer, at least one positively charged polyelectrolyte polymer, and wherein the coating has a glass transition temperature of at least 45° C. when in contact with an aqueous medium.

Aspect 2. The article of Aspect 1, wherein the negatively charged polyelectrolyte polymer comprises a hydrocarbon backbone and one or more aryl groups pendant to the backbone, wherein each aryl group comprises at least one anionic group.

Aspect 3. The article of Aspect 1, wherein the negatively charged polyelectrolyte polymer comprises a backbone with one or more aryl groups, wherein each aryl group comprises at least one anionic group.

Aspect 4. The article of Aspect 2 or 3, wherein the anionic group comprises a sulfonate group, a phosphate group, or phosphonate group.

Aspect 5. The article of Aspects 2-4, wherein the aryl group comprises a phenyl group.

Aspect 6. The article of Aspects 2-5, wherein one or more hydrogen atoms on the aryl group is substituted with one or more alkyl groups.

Aspect 7. The article of Aspect 1, wherein negatively charged polyelectrolyte polymer comprises a backbone with one or more phenyl groups, wherein each phenyl group has one or more sulfonate groups covalently bonded to the aryl group.

Aspect 8. The article of Aspect 1, wherein the negatively charged polyelectrolyte polymer comprises a sulfonated polyparaphenylene, a sulfonated polyetherether ketone, a sulfonated polysulfone, a sulfonated polyarylene, or a sulfonated polyarylene sulfone.

Aspect 9. The article of Aspects 1-8, wherein the positively charged polyelectrolyte polymer comprises a plurality of quaternary ammonium groups covalently bonded to the positively charged polyelectrolyte polymer.

Aspect 10. The article of Aspect 9, wherein the quaternary ammonium group comprises a nitrogen-bearing heteroaryl group, wherein nitrogen is alkylated.

Aspect 11. The article of Aspect 9, wherein the quaternary ammonium group comprises a nitrogen-bearing cycloalkyl group, wherein nitrogen is alkylated.

Aspect 12. The article of Aspect 11, wherein the nitrogen-bearing cycloalkyl group, is a four- to seven-member ring.

Aspect 13. The article of Aspect 9, wherein the quaternary ammonium group has the structure

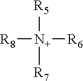

wherein R₅ is an aryl group or an alkylene group and is covalently bonded to the polymer backbone, and R₆, R₇ and R₈ are independently an alkyl group or an aryl group.

Aspect 14. The article of Aspects 1-9, wherein the positively charged polyelectrolyte polymer comprises a protonated or alkylated poly(pyridine), a protonated or alkylated poly(imidazole), a protonated or alkylated a poly(piperidine), or a protonated or alkylated poly(amine).

Aspect 15. The article of Aspects 1-9, wherein the positively charged polyelectrolyte polymer comprises poly(diallyldimethylammonium chloride) (PDADMA), poly(vinylbenzyltrimethylammonium) (PVBTA), ionenes, poly(acryloxyethyltrimethyl ammonium chloride), poly(methacryloxy(2-hydroxy)propyltrimethyl ammonium chloride), and copolymers thereof; polyelectrolytes comprising a pyridinium group such as poly(N-methylvinylpyridinium) (PMVP), including poly(N-methyl-2-vinylpyridinium) (PM2VP), and copolymers thereof; poly(allylaminehydrochloride) (PAH), polyvinylamine, polyethyleneimine (PEI); a polysulfonium, or a polyphosphonium.

Aspect 16. The article of Aspects 1-15, wherein the positively-charged polyelectrolyte and the negatively-charged polyelectrolyte has an average charge density of about 0.1 to about 2.0 per repeat unit.

Aspect 17. The article of Aspects 1-16, wherein the positively charged polyelectrolyte polymer and the negatively charged polyelectrolyte polymer has a weight average molecular weight of from about 1,000 grams/mole to about 5,000,000 grams/mole.

Aspect 18. The article of Aspects 1-17, wherein the polyelectrolyte complex has a particle size of about 0.01 micrometers to about 200 micrometers.

Aspect 19. The article of Aspects 1-18, wherein the polyelectrolyte complex further comprises a filler, a reinforcing agent, magnetic particles, or any combination thereof.

Aspect 20. The article of Aspects 1-19, wherein the polyelectrolyte complex further comprises a crosslinking agent.

Aspect 21. The article of Aspects 1-20, wherein the coating has a thickness of about 10 nanometers to about 1 millimeter.

Aspect 22. The article of Aspects 1-21, wherein the coating has a glass transition temperature of at least 80° C. when in contact with an aqueous media.

Aspect 23. The article of Aspects 1-21, wherein the coating has a glass transition temperature of at least 90° C. when in contact with an aqueous medium.

Aspect 24. The article of Aspects 1-23, wherein the coating has a net negative surface charge.

Aspect 25. The article of Aspects 1-23, wherein the coating has a net negative charge density greater than zero to about 10%.

Aspect 26. The article of Aspects 1-30, wherein the coating has a degree of hydration of about 15 weight percent to about 50 weight percent when in contact with an aqueous medium.

Aspect 27. The article of Aspects 22-26, wherein the aqueous medium comprises seawater.

Aspect 28. The article of Aspects 1-27, wherein the article comprises a hull of a nautical vessels, a pipe, a dock, a cable, a chain, a rope, a buoy, a weight, a propellor, or an anchor.

Aspect 29. The article of Aspects 1-28 further comprising a second polyelectrolyte complex coating with a glass transition temperature of less than 45° C. when in contact with an aqueous medium, wherein the second polyelectrolyte complex coating is disposed between the surface of the article and the coating that has a glass transition temperature of at least 45° C. when in contact with an aqueous medium.

Aspect 30. An article comprising a coating for reducing fouling on a surface of an article, wherein the coating is produced by the method comprising applying to the surface of the article a coating comprising a polyelectrolyte complex, the method comprising applying to the surface a composition comprising at least one negatively charged polyelectrolyte polymer, at least one positively charged polyelectrolyte polymer, counterions, and a solvent, and wherein the coating has a glass transition temperature of at least 45° C. when in contact with an aqueous media.

Aspect 31. The article of Aspect 30, wherein the solvent comprises water, an organic solvent, or a combination thereof.

Aspect 32. The article of Aspect 30, wherein the solvent comprises

water and formamide.

Aspect 33. The article of Aspect 32, wherein the formamide is from 10 weight percent to about 50 weight percent of the composition.

Aspect 34. The article of Aspects 30-33, wherein the composition has solids content of about 1 weight percent to about 80 weight percent.

Aspect 35. The article of Aspects 30-34, wherein after the composition is applied to the surface of the article to produce a coated article the coated article is heated.

Aspect 36. The article of Aspect 30-34, wherein the coated article is heated at a temperature of about 100° C. to about 200° C.

Aspect 37. The article of Aspects 30-34, wherein the composition is applied to the surface of the article at a temperature of about 100° C. to about 200° C.

Aspect 38. An article comprising a coating for reducing fouling on a surface of an article, wherein the coating is produced by the method comprising
(a) applying to the surface of the article a coating comprising a polyelectrolyte complex, the method comprising applying to the surface a composition comprising at least one negatively charged polyelectrolyte polymer, at least one positively charged polyelectrolyte polymer, and a solvent to produce a first coating;
(b) applying formamide to the first coating to produce a fused coating; and
(c) rinsing the fused coating with water to substantially remove the formamide from the fused coating, wherein the fused coating has a glass transition temperature of at least 45° C. when in contact with an aqueous media.

Aspect 39. The article of Aspect 38, wherein the solvent comprises water, an organic solvent, or a combination thereof.

Aspect 40. The article of Aspect 38 or 39, wherein the formamide is applied to the first coating in an amount from about 10 weight percent to about 100 weight percent relative to the first coating.

Aspect 41. An article comprising a coating for reducing fouling on a surface of an article, wherein the coating is produced by the method comprising sequentially applying to the surface of the article at least one negatively charged polyelectrolyte polymer composition and at least one positively charged polyelectrolyte polymer composition, and wherein the coating has a glass transition temperature of at least 45° C. when in contact with an aqueous media.

Aspect 42. The article of Aspect 41, wherein the method further comprises applying formamide to the coating.

Aspect 43. The article of Aspects 1-42, wherein the article reduces the adhesion of a microorganism to the article when compared to same article that has not been coated.

Aspect 44. The article of Aspect 43, wherein the microorganism is bacterial or algae.

Aspect 45. The article of Aspects 1-46, wherein the article reduces the adhesion of barnacles to the article when compared to same article that has not been coated.

Aspect 46. A composition comprising at least one negatively charged polyelectrolyte polymer, at least one positively charged polyelectrolyte polymer, counterions, and a solvent comprising water and formamide.

Aspect 47. A kit comprising
(a) a mixture comprising at least one negatively charged polyelectrolyte polymer and at least one positively charged polyelectrolyte polymer; and
(b) formamide.

Aspect 48. The kit of Aspect 47, wherein the mixture comprising the at least one negatively charged polyelectrolyte polymer and the at least one positively charged polyelectrolyte polymer is a dry powder.

Aspect 49. The kit of Aspect 47, wherein the mixture comprising the at least one negatively charged polyelectrolyte polymer and the at least one positively charged polyelectrolyte polymer is in a solvent.

Aspect 50. The kit of Aspects 47-49, wherein the kit further comprises an applicator for applying independently the mixture comprising at least one negatively charged polyelectrolyte polymer, at least one positively charged polyelectrolyte polymer, and formamide.

### EXAMPLES

The following examples are put forth so as to provide those of ordinary skill in the art with a complete disclosure and description of how the compounds, compositions, articles, devices and/or methods claimed herein are made and evaluated, and are intended to be purely exemplary of the disclosure and are not intended to limit the scope of what the inventors regard as their disclosure. Efforts have been made to ensure accuracy with respect to numbers (e.g., amounts, temperature, etc.), but some errors and deviations should be accounted for. Unless indicated otherwise, parts are parts by weight, temperature is in ° C. or is at ambient temperature, and pressure.

### Materials

Poly(ether ether ketone) (PEEK) powder, from Evonik (VESTAKEEP™ 4000 FP), or Victrex (450 PF) was dried at 120° C. for 5 h under vac. Concentrated sulfuric acid (Sigma-Aldrich, ACS grade, 96.7 wt. %) was used as received. Poly(diallyl dimethylammonium chloride) (PDADMAC, 20 wt. % in water, molar mass 400,000-500,000), poly(4-styrenesulfonic acid) (PSS, 18.89 wt. % in water, molar mass 75,000), and poly(vinylbenzyltrimethylammonium chloride) (PVBT, 26.9 wt. % in water, molar mass 100,000) were from Sigma-Aldrich. Methacryloylaminopropyl trimethylammonium chloride (MAPTAC, 50 wt. % solids in water) was polymerized via free radical polymerization to obtain the polymer PMAPTAC (molar mass 350,000), poly (acrylic acid) (PAA, 24 wt. % in water, molar mass 240,000) was obtained from Scientific Polymer Products Inc. and neutralized with LiOH. Lithium hydroxide (anhydrous) was from Fisher and stored in the glovebox. Sodium chloride (99.5%) was used as received from Sigma-Aldrich. Deionized water (>18 MΩ cm) was used throughout. Silicon wafers (Si 100, double-side-polished, DSP, Prime grade, 0.5 mm thick) were from Okmetic and broken into ca. 2 cm×2 cm pieces.

Chlamydomonas reinhardtii (+) (Carolina Biological) was cultured as described by Sager and Granick.⁴⁴ Cultures were grown in a 14 h light/10 h dark cycle at 25° C. to a density of 5×10⁶ cells mL⁻¹ as determined using a hemocytometer (Neubauer). A parallel plate flow chamber channel (75 mm long×25 mm wide×1 mm high) built in-house was used to study the influence of flow rate on algae detachment from PEMUs coated on glass microscope slides. Bare microscope slides were used as a control. Microscope slides were pre-cleaned with ethanol then flamed before multilayers were deposited onto the substrate using the layer-by-layer method.⁴⁵ The PEMU coated substrate was then immediately dipped into a solution containing the algae for 24 h with stirring, after which it was removed gently and placed in the flow chamber. Images were collected using the Nikon Eclipse TS100 microscope fitted with a Nikon DS-Ri1 Camera.

PEEK Sulfonation. Sulfonation of PEEK was carried out by adding 10 g of dry PEEK powder to 100 mL sulfuric acid. The mixture was stirred in a three-necked flask at 75±1° C. for 6 h under N₂.⁴⁶ Following sulfonation, the dissolved sulfonated PEEK, SPEEKH, was precipitated by pouring it into 500 mL ice cold water. The precipitated sample was repeatedly washed on a vacuum filter with ice cold water to remove excess sulfuric acid. The washed sample was then re-heated at 50° C. in small amount of deionized water to dissolve the SPEEKH. The SPEEKH was neutralized with 1 M LiOH (Scheme 1). Neutralized SPEEK (SPEEKLi) was dialyzed against water for two weeks with water replacement twice a day. Solid SPEEKLi was then obtained by freeze drying the product.

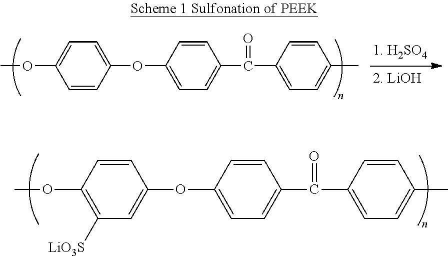

Hydrodynamic Radius. Dynamic light scattering was used to measure the SPEEK hydrodynamic radius, Rₕ, with a goniometer system (ALV/LSE-5004) equipped with a He-Ne laser (λ=632 nm, 22 mW) at a 90° collection angle. Measurements were taken in 10 mm capped cylindrical borosilicate glass tubes through a reservoir containing a refractive index matching liquid (toluene). The samples were 1 mg mL⁻¹ in aqueous 0.3 M LiCl, filtered through a 0.1 μm Millipore filter. The Rₕ was calculated along with the distribution of Rₕ by pseudo-cross-correlation of the signals obtained by the two photomultipliers. The intensity autocorrelation function g⁽²⁾(q, T) where

$$q = 4 π {n}_{D} sin ( θ / 2 ) / λ$$

was obtained with suppressed noise by using ALV correlator software V.3.0.

Layer by Layer Buildup. Multilayers from PMAPTA/SPEEK, PDADMA/SPEEK, PVBT/SPEEK, PVBT/PSS, PDADMA/PSS and PDADMA/PAA were built using a robot (StratoSequence V, nanoStrata Inc.) on double-side-polished silicon wafers, which allowed transmission FTIR, or on single-side-polished Si wafers for ellipsometry and AFM measurements. PEMUs were also built on clean fused silica slides for UV-vis absorbance measurements. All substrates were cleaned in “piranha” (70% H₂SO₄/30% H₂O₂) for 30 min after which they were vigorously rinsed with water and dried with a stream of N₂. (Caution! Piranha is strongly oxidizing and should not be stored in closed containers.). Polymers solutions were 10 mM (based on the repeat unit) for ellipsometry, transmission FTIR and algae adhesion measurements. The substrates were mounted onto a shaft and rotated at 300 rpm. Substrates were alternately dipped in each polymer for 10 min, starting with the polycation, followed by three 1 min rinsing steps in water. Multilayers with an odd number of layers (terminating in polycation) have a positive surface charge whereas even numbers of layers yielded negative surfaces.

Streaming Potential Measurement. Surface streaming measurements were obtained using an in-house built electrokinetic flow cell with a parallel plate configuration. A clean microscope slide (75 mm×25 mm) was inserted on the bottom half of the cell while the top glass had 1 mm holes allowing inlet and outlet flow of electrolyte. The top and bottom glass slides were clamped together using a rubber spacer (length=17 mm, width 5 mm and height of 0.1 mm) creating a micro-flow channel. The parallel plate set-up (at the glass-liquid interface) were fitted with silver wire electrodes connected to a Keithley voltmeter to measure the streaming potential. A 10 L reservoir with a pressure gauge containing 1 mM NaCl was pressurized with N2 to force electrolyte through the cell. The pressure difference across the sensor wires was measured with a calibrated Validyne P55 differential pressure transducer. The zeta potential, ζ (mV), was calculated using the following equation:⁴⁷

$$\frac{{E}_{s}}{Δ P} = \frac{{ε}_{r} {ε}_{0} ζ}{{λ}_{b} μ}$$

where Eₛ is the measured streaming potential (mV). ΔP, the pressure drop between the Ag sensor electrodes, was 1.87×10⁴ Nm⁻². μ, the viscosity of the streaming solution was, 1.0×10⁻³ Nsm⁻², εᵣ, the relative dielectric permittivity of the streaming solution was 80 while ε₀ is the permittivity of vacuum, 8.85×10⁻¹² Ssm⁻¹. Bulk solution conductivity, λ_{b} was 2.19×10⁻² Sm⁻¹ as measured using an Orion 3 Star 4-point conductivity probe and meter from Thermo Scientific.

Surface Charge Radiolabeling. The actual number of SPEEK charges on SPEEK-terminated surfaces was measured using ultrasensitive radiolabel techniques. Si wafers approximately 2 cm×2 cm coated with 10 layers (terminating in SPEEK) were used. Wafers were exposed on one side to 300 μL 2.5×10⁻⁵ M ¹⁴C-labeled tetraethylammonium bromide (¹⁴C-TEABr from Perkin Elmer Radiochemicals, specific activity 3.5 Ci mol⁻¹) for 1 h. We have shown previously that the TEA⁺ cation only labels the surface negative sites on multilayers.³² The solution was blown off the surface with a jet of N₂. The labeled TEA on the surface was extracted with 300 μL of 1×10⁻³ M unlabeled TEABr. This 300 μl was mixed with 2 ml of water-tolerant liquid scintillation cocktail (Ecolite, MP Biochemicals) and counted in a Charm II counter (Charm Sciences). 300 μL of 2.5×10⁻⁵ M ¹⁴C-TEABr was used as a standard to convert counts per minute, cpm, to moles of ions per cm². Wafers coated with 3 layers (PDADMA/SPEEK/PDADMA), to which TEA⁺ does not adsorb, were used as background, employing the same procedure as with the SPEEK-terminated multilayers. Typical counts on the SPEEK surfaces were around 400 cpm, and those on the background were about 70 cpm, which were from the film of electrolyte that remained after jet-blowing the surface.

Ellipsometry. The dry thicknesses of PEMUs prepared on Si wafer were obtained by using a Gaertner Scientific L116S autogain variable-angle Stokes ellipsometer equipped with a He-Ne laser (632.8 nm) at an incident angle of 70°, fixing the refractive index of the films at 1.54 and that of Si (substrate) at 3.85. Ten thickness measurements on each PEMU were averaged. A native oxide layer of about 1 nm was subtracted from the measurements.

NMR Characterization. ¹H solution NMR spectroscopy (Bruker Avance 400 MHz) was used to determine the degree of sulfonation.⁴⁸ Dry SPEEKLi (sulfonated from Vestakeep™ 4000 FP PEEK), was dissolved in a 90:10 DMSO:D₂SO₄ solvent mixture ratio while dry SPEEKLi (sulfonated from Victrex 450 PF PEEK), was dissolved in a 95:5 DMSO: D₂SO₄ mixture to obtain 15 mg mL⁻¹ solutions.

FTIR Studies. Transmission Fourier transform infrared (FTIR) spectra of samples prepared on DSP Si wafers were obtained with a Nicolet Nexus 470 FTIR spectrometer with a DTGS detector. The resolution was 4 cm⁻¹, and 256 scans were averaged for each sample. Samples were held at 15° off-perpendicular to reduce any interference fringes. The background for all spectra was taken on uncoated Si. Attenuated total reflection—Fourier transform infrared (ATR-FTIR) spectra were collected using a ThermoScientific Nicolet is20 equipped with a Pike MIRacle ATR attachment fitted with a single-reflection diamond/ZnSe crystal and a high-pressure clamp. Here, background for all spectra was ambient air.

UV-Visible Spectroscopy (UV-vis). UV-vis spectra were collected with a Cary 100 Bio UV-Vis spectrometer. UV-vis spectra were recorded on 0.05 mM SPEEKLi in 0.3 M LiCl and on multilayers on fused silica slides.

Contact Angle Measurements. Water contact angles on PEMUs were measured using a contact angle goniometer (KSV Instruments, CAM 200) at room temperature. The static contact angle was digitally captured using a 70 λL mL water droplet, and image analysis software was used to measure the contact angles.

Atomic Force Microscopy Images. Images of the surface of PEMUs were recorded with a Dimension Icon Scanning Probe Microscope (SPM), equipped with a NanoScope V controller and NanoScope software (in tapping mode), and silicon OTESPA probes (Bruker, 0.01-0.02 Ω cm Si, tip radius=7±2 nm, cantilever thickness=4.6 μm, length=160 μm, width=50 μm, resonance frequency 300 kHz, spring constant k=42 N m⁻¹ coated with Al). Images were scanned at a rate of 1 Hz, with a scan size of 5 μm×5 μm. The rms roughness was measured on 5 different 1 μm×1 μm scan areas and averaged.

Stability of Films. The stability of the three SPEEK multilayers in salt was tested by exposing them to 2 M NaCl and 3 M NaCl for 1 week at room temperature. Thicknesses of 10-layer multilayers on Si wafer were measured using ellipsometry before and after exposure. Scanning Electron Microscopy, SEM, images of films were also acquired before and after salt exposure using a JEOL JSM-IT800 field emission SEM equipped with a secondary electron detector (SED) at 5 kV accelerating voltage. Samples were rinsed in water before imaging to remove salt. Some of the multilayers were scratched with tweezers to reveal the film profile.

Rheology of Polyelectrolyte Complexes, PECs. Complexes for bulk rheology were prepared by simultaneously combining stoichiometric mixtures of 10 mM polyelectrolyte solutions in 0.3 M LiCl. The PECs were annealed at 60° C. for 7 h to ensure 1:1 good mixing. Precipitates were equilibrated in 0.01 mM LiCl followed by water to remove any excess salt. Tablets (8 mm diameter×2 mm thickness) of PDADMA/SPEEK, PVBT/SPEEK and PMAPTA/SPEEK PECs were prepared by wet compression molding with 0.01 M LiCl electrolyte using a steel mold at temperatures close to the glass transition temperature, T_{g}. of the complex. Using a stress-controlled DHR-3 rheometer (TA Instruments), the linear viscoelastic response, LVR, of the complexes was investigated as a function of temperature. The tablets were placed on the lower plate of the rheometer and compressed using 1 N axial force. During rheology, all samples were maintained in a reservoir containing 0.01 M LiCl so that they would remain fully hydrated. After use, tablets were weighed, dried at 120° C. to constant weight, and weighed again to determine the water content.

Isothermal Titration calorimetry (ITC). Isothermal calorimetry was performed using a VP-ITC (MicroCal Inc.) calorimeter. The ITC was calibrated with an internal y-axis calibration followed by a standard titration between hydrochloric acid and Tris base. All samples were degassed for 10 min at room temperature. Approximately 300 μL of 10.0 mM polycation in 0.30 M LiCl was loaded into the syringe. Ten microliters of the solution was manually discharged from the syringe to relieve any back pressure from the loading process. The sample cell (1.4138 mL) was washed, then loaded, with 0.5 mM SPEEKLi in 0.30 M LiCl. Prior to injection, the ITC was allowed to equilibrate at 65.0° C. The syringe was rotated at 260 rpm in the sample cell with an injection size of 4 μL per aliquot at a rate of 0.50 μL s⁻¹, with 240 s between injections. The heat flow was recorded as a function of time at 65.0° C. for all samples. Enthalpies were calculated by summing the total heat generated to the 1:1 end point with a correction for the background dilution enthalpy.

### Results and Discussion

Whether polyelectrolyte complexes in general are glassy or liquid-like is not reliably correlated to the water content.³¹ Water plasticizes PECs to a point,^{49, 50} after which it appears to simply dilute the dense crosslinks inherent to complexes. The chemical identity of the charge pairing interactions is important, as some combinations of Pol⁺ and Pol⁻ provide slower pairing dynamics. Most of the polyelectrolyte pairs used here produce glassy material when combined as a complex, even when they are fully hydrated in salty water.³¹ Though previously employed in PEMUs,⁵¹ the potential glassy nature of PECs containing sulfonated PEEK has not been established. SPEEK is rod-like with high aromatic content and a charge of one sulfonate per three aromatic rings (see Scheme 1). SPEEK was prepared by sulfonation of PEEK using concentrated H₂SO₄ at 75° C. The ¹H NMR spectrum showed full sulfonation according to the structure in Scheme 1 without evidence of additional charge. The FTIR spectra are also consistent with full sulfonation.

A versatile method to produce ultrathin films of PEC employs the layer-by-layer assembly of component polyelectrolytes (see Scheme 2) from aqueous solution.⁴⁵ The layers may be produced by alternating dipping or, much more quickly, by alternating spraying of individual polyelectrolytes⁵² usually starting with the polycation, as ambient surfaces are commonly negatively charged. Various combinations of polycations and polyanions assembled as multilayers have been reported to reduce fouling. Kurtz et al.⁵³ reported that when compared to control glass slides, PDADMA/PSS films reduced the adhesion of E. coli. Zhu et al.⁵⁴ reported that layer-by-layer films (crosslinked and non-crosslinked) demonstrated antifouling properties by preventing the adhesion/settlement of amphora and cyprids under static experimental conditions. We have previously reported that a coating of PSS on DOWEX X8 anion-exchange resin prevented fouling by C. reinhardtii. Uncoated resins, which are positively charged, permitted significant cell attachment, sequestering about 80% of the added algae.³⁷

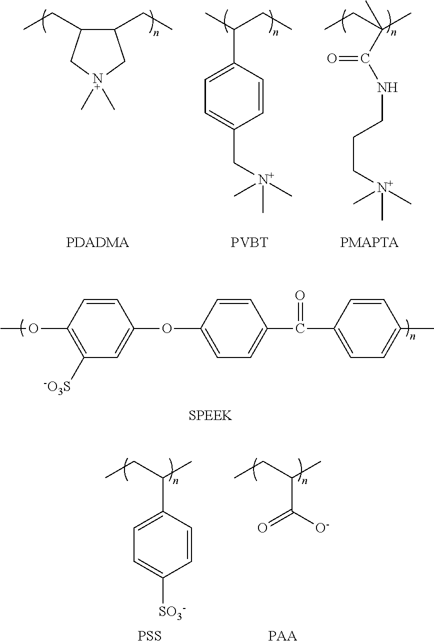

Scheme 2. Structures of polyelectrolytes employed. Counterions not shown.

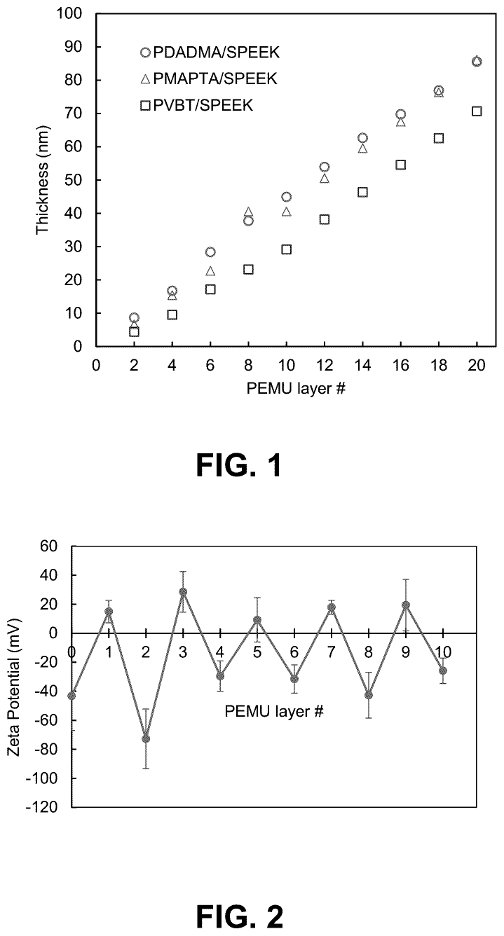

FIG. 1 shows a linear buildup of thickness with the number of layers deposited. Multilayer buildup was tracked using ellipsometry on the native oxide surface of silicon wafers or on fused silica via UV-vis absorption spectroscopy. Each layer was deposited from a 10 mM solution of polymer in 0.3 M LiCl by dipping in the solution for 10 mins followed by three 1 min rinses in water.

Linear multilayer growth is correlated with strongly-interacting polyelectrolytes and glassy PECs in particular.⁵⁵ In such a scenario, incoming polyelectrolyte charge compensates the existing charge but does not strongly overcompensate or diffuse in,³² meaning a small amount of polyelectrolyte is added on each “layer” and the bulk of the multilayer remains charge balanced. The liquid-like properties of weak multilayers⁵⁶ permit equilibrium excess charge, or overcompensation, to accumulate in the film, which yields nonlinear or “exponential” growth.⁵⁷ Many glassy multilayers exhibit a few layers of initial nonlinear growth. PDADMA/PSS, with a T_{g} of about 35° C., transitions from nonlinear to linear after about 14 layers.³² The immediate linearity of the SPEEK combinations is taken as an indication of strongly glassy properties. The charge density of SPEEK is low relative to many polyelectrolytes, while the backbone is relatively stiff. Sulfonation of PEEK beyond the level shown in Scheme 2 is difficult to achieve without degradation, since the introduction of the SO₃_{^{−}} group in the location shown in Scheme 2 deactivates further sulfonation.⁵⁸

While counterion release from polyelectrolytes is always present as a driving force for complexation,²⁸ enthalpy changes modify the strength of interactions.⁵⁶ PECs with an exothermic complexation enthalpy, ΔH_{PEC}, suggest strong complexation. Isothermal titration calorimetry, often used to measure ΔH_{PEC},^{56, 59} provided surprisingly low values at room temperature. Due to the glassy nature of the complex, it was suspected that charge pairing between positive and negative repeat units was kinetically arrested and thus incomplete. When the ITC was repeated at 65° C. to accelerate this pairing, all polyelectrolytes showed exothermic complexation. Observations of the thickness increment for each layer showed that each SPEEK layer was about 1 nm thicker than the polycation layer, which is to be expected, since the SPEEK repeat unit is heavier than those of the Pol⁺ repeat units. While this suggests good pairing between bulk Pol⁺ and Po⁻, the error for each layer thickness was about ±25%. Near-stoichiometric pairing was inferred from FTIR observations. FTIR spectroscopy of multilayers on Si wafers showed the presence of both polymers. The bands from PVBT were weak compared to those from PSS, but a spectrum of bulk complex known to be stoichiometric showed a spectrum that was almost identical to that of the multilayer.

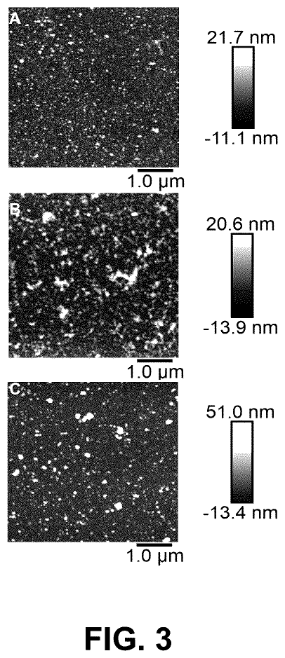

The surface charge switches between negative and positive depending on the identity of the last-added “layer,” as seen in FIG. 2. Generally, a neutral or net negative, weak surface charge favors antifouling properties.^{8, 30} At the molecular level, the release of surface counterions is a strong driving force for nonspecific adsorption.³⁰ Therefore, surfaces with few or no charges are desired, a criterion met by PEG, polyacrylamide and other neutral hydrophilic polymers. Zwitterionic surfaces are also nominally net-neutral, though they usually bear an apparent negative charge in use. ^{60, 61, 62}

Many of the excess ions in an electrical double layer are adsorbed in the Stern layer.⁶³ Converting zeta potential to “apparent” surface charge does not account for these ions, which are liberated when they are exchanged by the adsorption of materials with the same charge. This ion release represents an entropic driving force.³⁰ The radiolabeling technique described above replaces all excess counterions at the surface, including those in the Stern layer. The ¹⁴C— radiolabeled probe ion, tetraethylammonium, revealed a low population of positive counterions at SPEEK-terminated surfaces (see Table 4), consistent with a low negative charge density from excess SPEEK. This low charge density is critical in minimizing the entropic driving force for adsorption of released counterions.

TABLE 4
Surface charge densities of cation (counterions) on SPEEK-terminated PEMUs

| | | Surface | Surface | |
|---|---|---|---|---|
| | Molar Mass | Cation Charge | Density of | % Monolayer |
| | Pol⁺Pol⁻ Repeat | Density | Pol⁺Pol⁻ Pair^{a} | of Cation |
| Multilayer | Unit g mol⁻¹ | (mole cm⁻²) | (mole cm⁻²) | Charges |
| PDADMA/SPEEK | 531 | 1.60 × 10⁻¹¹ | 2.04 × 10⁻¹⁰ | 7.8 ± 0.6 |
| PVBT/SPEEK | 602 | 1.79 × 10⁻¹¹ | 1.87 × 10⁻¹⁰ | 9.6 ± 0.8 |
| PMAPTA/SPEEK | 583 | 3.23 × 10⁻¹¹ | 1.91 × 10⁻¹⁰ | 16.9 ± 1 |

^{a}assumes a density of PEC = 1.2 g cm⁻³

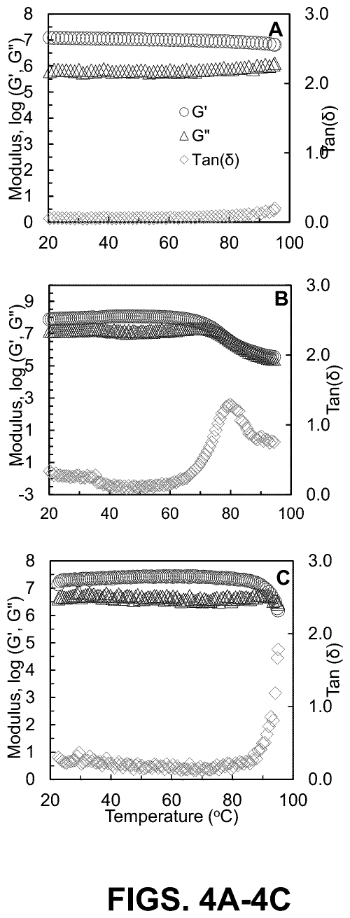

Antifouling coatings usually benefit from a smooth surface,^{64, 65} although some topographical features discourage settlement of organisms under flow.^{66, 67} The surface roughness of the PEMUs was investigated using atomic force microscopy (AFM). The samples for this measurement were prepared on a single-side-polished silicon wafer. AFM images (FIG. 3) showed that PDADMA/SPEEK had the lowest rms surface roughness, Rₐ, of 3.0 nm, followed by PVBT/SPEEK, Rₐ of 4.1 nm, and PMAPTA/SPEEK, with an Rₐ of 4.5 nm. The images reveal a few scattered features from 10-100 nm in size. Although the solution was passed through filters of (nominal) 100 nm pore size, particles smaller than 100 nm would not have been excluded. In addition, SPEEKLi is only barely soluble in water. Partial aggregation could explain the AFM features greater than 10 nm. Nevertheless, the results below suggest these features do not compromise the antifouling properties of the modified surface. Point theory⁶⁸ is commonly used to relate the interaction of micro-organisms on rough surfaces. For example, Cui et al. showed experimentally that attachment of foulants is significantly improved when the engineered surface feature was similar to the diameter of the adhering cell (foulant).⁶⁹ For our surfaces, sectional analysis revealed roughness in orders of nanometers, significantly smaller than the model foulant Chlamydomonas reinhardtii which is on the order of 10 μm in size. Static water contact angles were between 43 and 72 degrees, which are intermediate between hydrophilic and hydrophobic.

SEM images of 10-layer versions of the three PEMUs (45 nm thick) in FIG. 3 reveal the same morphology: a pinhole-free, uniform coating. Scratched areas show the smooth Si wafer underneath and fully dense films with the thickness measured via ellipsometry. Films remained adhered to the substrate when adhesive tape was pulled off them (the peel test). The stability of films in solutions of high salt concentrations was determined by measuring changes in ellipsometric film thickness after 1 week in 2 M and 3 M NaCl. Working with 10-layer PEMUs there was no significant change in the thickness (+/−10%) of any of the SPEEK-containing multilayers after 1 week of immersion in 2 M NaCl at room temperature. The coatings also remained intact in 3 M NaCl for a week, but appeared to become somewhat rougher, perhaps a result of modest doping/swelling by the high [NaCl].

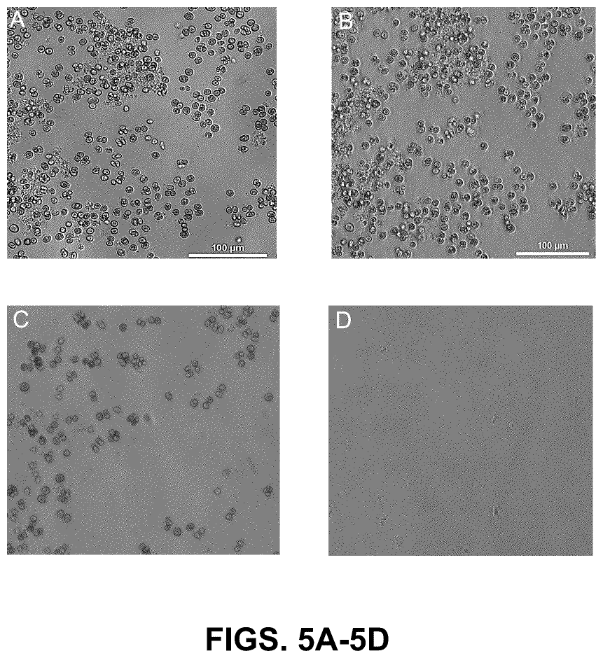

Measuring the viscoelastic properties of film of thickness <100 nm is challenging. In contrast, there are more accurate/reliable methods of viscoelastic measurements on bulk samples. Using a rheometer, dynamic mechanical thermal analysis on stoichiometric SPEEK complexes (FIG. 4) revealed that these systems were glassy with T_{g} of >100° C. for PVBT/SPEEK, an estimated T_{g} of 103° C. for PDADMA/SPEEK, and 79° C. for PMAPTA/SPEEK. Storage modulus G′ remains constant at about 10 MPa, and loss modulus G″ about an order of magnitude lower, across a wide temperature range. A maximum in tanδ (=G″/G′) showing a clear T_{g} is only observed with PMAPTA/SPEEK (FIG. 4). The water content, measured by drying the 8 mm diameter tablets after rheology was completed, is given in the caption of FIG. 4.

### Cell Adhesion Analysis

While passive antifouling is the ultimate property sought from these coatings, it is difficult to measure the difference between non-adhered and weakly adhered organisms or protein, as a rinsing step is usually required. In the present case, slides were maintained vertically for 24 h in a dense solution of algae under stirring, then removed carefully without rinsing and placed horizontally in a flow chamber for observation. The same medium used to grow the algae was then passed through the chamber. The term “antifouling” in the present case refers to the population of algae removed at the lowest flow rate available (0.8 cm s⁻¹ linear velocity). This is considerably less than using a “gentle stream” of media from a quirt bottle, which is a typical method of removing unabsorbed species.

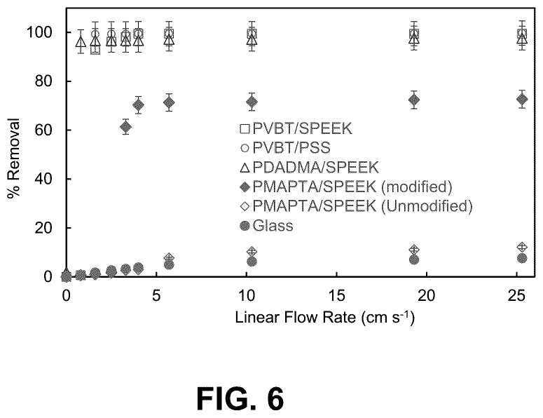

Observations on 10-layer PDADMA/SPEEK multilayers, ca. 40 nm thick, showed complete removal of all algae at the minimum flow rate (FIG. 5). The control, clean bare glass, showed almost no removal of algae under the same conditions.

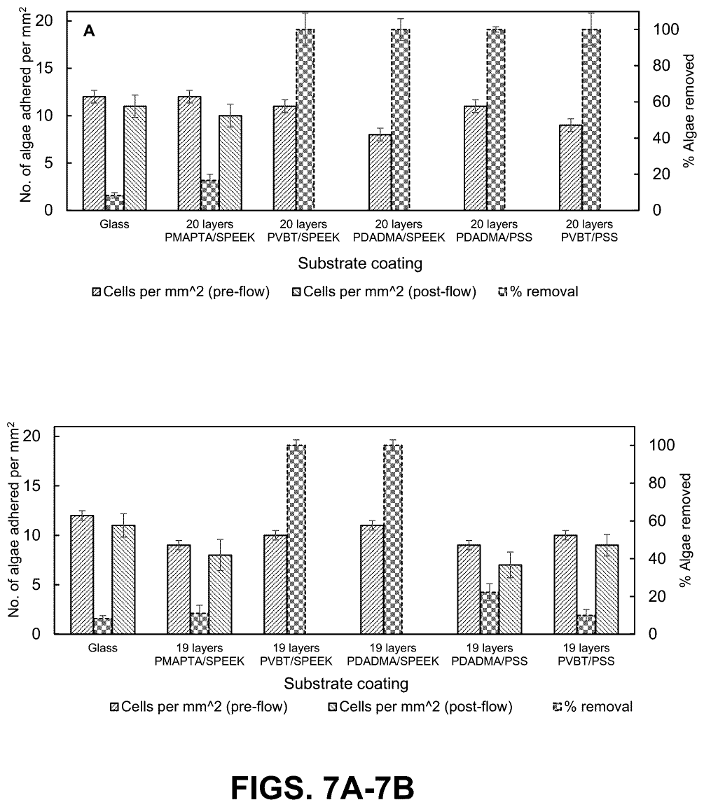

Algae attachment versus shear rate for other SPEEK-containing multilayers was compared: PMAPTA/SPEEK; PVBT/SPEEK; and also PVBTA/PSS (see FIG. 6). Above a very gentle flow of 1.6 cm s⁻¹ the algae were removed from most of the coatings. The as-made PMAPTA/SPEEK film showed evidence of fouling, as few cells were released to the highest flow rate employed (25 cm s⁻¹)—behavior similar to the uncoated glass control (FIG. 6).

Because of the poor performance of the as-made PMAPTA/SPEEK coating (FIG. 6), the deposition for this pair of polyelectrolytes was modified by leaving the multilayer in the final SPEEK dip for 1 h instead of the usual 10 min. This additional contact time with the SPEEK solution allowed the accumulation of more SPEEK at the surface. As seen in FIG. 6, this coating exhibited a partial fouling release response, with a minimum flow rate of 3.3 cm s⁻¹ required to release about 70% of the algae. Additional algae were not released at higher flow rates. Montero et al. reported decreased biofilm formation on sulfonated PEEK surfaces.⁴⁸ The reasons the PMAPTA/SPEEK coatings were not as effective as the other two quaternary ammonium/SPEEK combinations are not known, but PMAPTA/SPEEK did have the lowest T_{g} (FIG. 4).

A multilayer of PDADMA and PAA was used to compare the performance of a soft film. Complexes with PAA or poly(methacrylic acid) tend to have T_{g}s below room temperature,³¹ reflected in a liquid-like or “coacervate” morphology. PDADMA/PAA is gel-like and grows exponentially in solutions containing salt.⁶⁸ A 10-layer PDADMA/PAA multilayer showed weak attachment of algae, which were mostly removed by a gentle flow of 1.6 cm s⁻¹. Increasing the flow to 20 cm s⁻¹ removed the rest of the algae. However, PDADMA/PAA is not stable in salt solutions of the concentration in seawater.^{70. 71} PAA combined with PAH is more tolerant of salt.⁷² By encouraging a high level of hydration (and softness) in a PEMU of PAH and PAA Mendelsohn et al. showed that fibroblast adsorption was prevented.⁴⁰

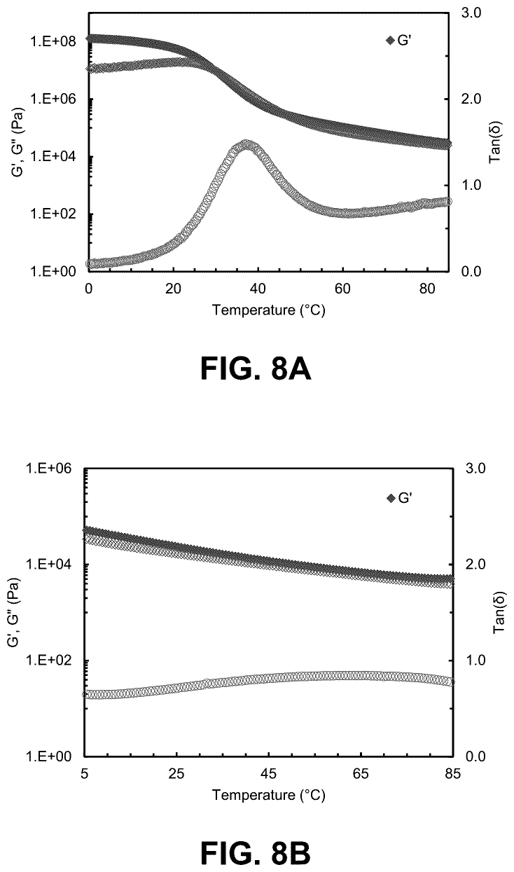

The surface charge is determined by the identity of the last layer (FIG. 2), which is positive for an odd number of layers and negative for an even number (deposition always starts with the polycation). The influence of surface charge on adhesion is illustrated in FIG. 7. All coatings except PMAPTA/SPEEK were effective for 20 layers, whereas two of the coatings failed to prevent algal adhesion when the number of layers was reduced to 19. The effectiveness of 19 layers of PVBT/SPEEK and PDADMA/SPEEK was surprising, but it may indicate a near-neutral surface charge. In fact, the zeta potentials for the odd PDADMA/SPEEK films were lower in magnitude than those for the even layers (FIG. 2). The 20-layer PMAPTA/SPEEK film showed partial foul-release behavior over time under flow as did the 19-layer PDADMA/PSS film.

C. reinhardtii, like many other flagellar systems, are able to interact with (interrogate) surfaces via their flagella. A negatively charged surface would electrostatically repel⁶⁴ the negatively charged N-glycan proteins that populate the cell walls of the flagella.⁷³ The persistent fouling seen in most of the positively-charged surfaces could be explained in a similar way. A maximum of 20% detachment of adhered algae was observed at the highest flow rate for those films. Prior studies of algae adhesion to charged surfaces revealed that positively charged surfaces enhance the adhesion of foulants such as algae^{74.75} in agreement with most of the data in FIG. 7B.

### Use of Formamide to Produce Glassy Coatings

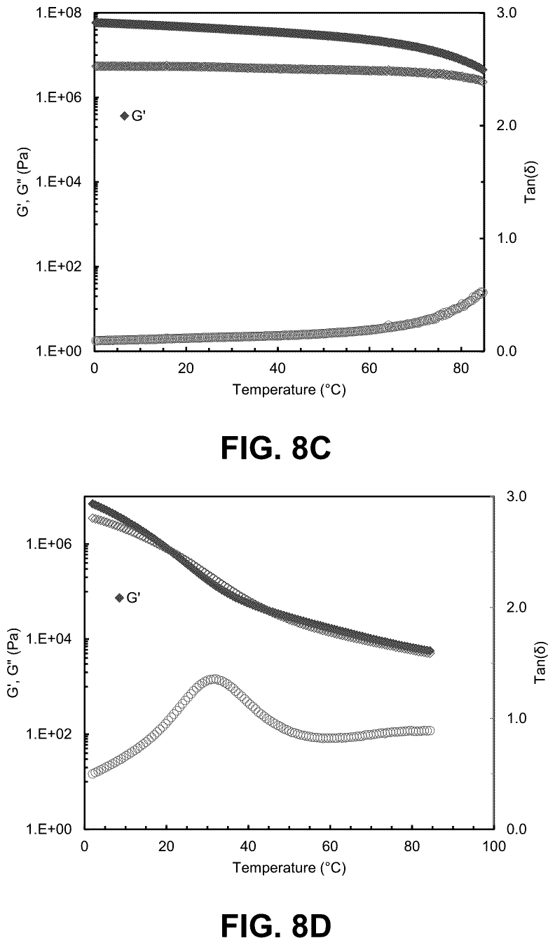

The use of formamide was evaluated to assess the effect on glass transition temperature of the coating. When no formamide was in contact with PDADMA/PSS, the polyelectrolyte complex has a clear Tg less than 45° C. in 100% aqueous solutions (FIG. 8A). However, when the same PDADMA/PSS complex was exposed to a solution with 25 weight percent formamide the polyelectrolyte complex has a Tg significantly less (below 5° C.) when compared to the same coating that was not prepared with formamide (FIG. 8B). Similar results were observed for PVBTA/PSS (FIGS. 8C and 8D with 0% and 50% formamide, respectively), where the Tg was lowered by approximately 70 degrees with the addition of formamide By lowering the glass transition temperature with the use of formamide, the polyelectrolyte complex can be softened close to room temperature to fuse particles. The formamide may be rinsed out with water to restore the original, higher Tg in the presence of water solutions.

In view of the above, it will be seen that the several objects of the invention are achieved and other advantageous results attained.

As various changes could be made in the above compositions and processes without departing from the scope of the invention, it is intended that all matter contained in the above description and shown in the accompanying drawings shall be interpreted as illustrative and not in a limiting sense.

### REFERENCES

ADDIN EN.REFLIST 1. Callow, J. A.; Callow, M. E. Trends in the Development of Environmentally Friendly Fouling-Resistant Marine Coatings. Nat Commun 2011, 2, 244.
2. Schultz, M. P.; Bendick, J. A.; Holm, E. R.; Hertel, W. M. Economic Impact of Biofouling on a Naval Surface Ship. Biofouling 2011, 27, 87-98.
3. Meloni, M.; Correa, N.; Pitombo, F. B.; Chiesa, I. L.; Doti, B.; Elías, R.; Genzano, G .; Giachetti, C. B.; Giménez, D.; López-Gappa, J.; Pastor, C.; Wandeness, A. P.; Ramírez, F. C.; Roccatagliata, D.; Schulze-Sylvester, M.; Tatián, M.; Zelaya, D. G.; Sylvester, F. In-Water and Dry-Dock Hull Fouling Assessments Reveal High Risk for Regional Translocation of Nonindigenous Species in the Southwestern Atlantic. Hydrobiologia 2021, 848, 1981-1996.
4. Chambers, L. D.; Stokes, K. R.; Walsh, F. C.; Wood, R. J. K. Modern Approaches to Marine Antifouling Coatings. Surf Coat Tech 2006, 201, 3642-3652.
5. Paz-Villarraga, C. A.; Castro, Í. B.; Fillmann, G. Biocides in Antifouling Paint Formulations Currently Registered for Use. Environmental Science and Pollution Research 2022, 29, 30090-30101.
6. Beans, C. News Feature: How “Forever Chemicals” Might Impair the Immune System. P Natl Acad Sci USA 2021, 118, e2105018118.
7. Lagerström, M.; Wrange, A.-L.; Oliveira, D. R.; Granhag, L.; Larsson, A. I.; Ytreberg, E. Are Silicone Foul-Release Coatings a Viable and Environmentally Sustainable Alternative to Biocidal Antifouling Coatings in the Baltic Sea Region? Marine Pollution Bulletin 2022, 184, 114102.
8. Ikada, Y. Blood-Compatible Polymers. Advances in Polymer Science 1984, 57, 103-140.
9. Chen, S. F.; Li, L. Y.; Zhao, C.; Zheng, J. Surface Hydration: Principles and Applications toward Low-Fouling/Nonfouling Biomaterials. Polymer 2010, 51, 5283-5293.
10. Luk, Y. Y.; Kato, M.; Mrksich, M. Self-Assembled Monolayers of Alkanethiolates Presenting Mannitol Groups Are Inert to Protein Adsorption and Cell Attachment. Langmuir 2000, 16, 9604-9608.
11. Jeon, S. I.; Lee, J. H.; Andrade, J. D.; Degennes, P. G. Protein Surface Interactions in the Presence of Polyethylene Oxide .1. Simplified Theory. J Colloid Interf Sci 1991, 142, 149-158.
12. Currie, E. P. K.; Norde, W.; Cohen Stuart, M. A. Tethered Polymer Chains: Surface Chemistry and Their Impact on Colloidal and Surface Properties. Adv Colloid Interfac 2003, 100-102, 205-265.
13. Milatz, R.; Duvigneau, J.; Vancso, G. J. Dopamine-Based Copolymer Bottlebrushes for Functional Adhesives: Synthesis, Characterization, and Applications in Surface Engineering of Antifouling Polyethylene. ACS Applied Materials & Interfaces 2023, 15, 34023-34030.
14. Sarker, P.; Lu, T.; Liu, D.; Wu, G.; Chen, H.; Jahan Sajib, M. S.; Jiang, S.; Chen, Z.; Wei, T. Hydration Behaviors of Nonfouling Zwitterionic Materials. Chemical Science 2023, 14, 7500-7511.
15. Ostuni, E.; Chapman, R. G.; Liang, M. N.; Meluleni, G.; Pier, G.; Ingber, D. E.; Whitesides, G. M. Self-Assembled Monolayers That Resist the Adsorption of Proteins and the Adhesion of Bacterial and Mammalian Cells. Langmuir 2001, 17, 6336-6343.
16. Zou, P.; Hartleb, W.; Lienkamp, K. It Takes Walls and Knights to Defend a Castle—Synthesis of Surface Coatings from Antimicrobial and Antibiofouling Polymers. J Mater Chem 2012, 22, 19579-19589.
17. Chiang, C.-T.; Vu, V. T.; Cheng, Y.-T.; Huang, C.-J. Methacrylate Silatrane: New Building Block for Development of Functional Polymeric Coatings through Controlled Silanization. ACS Applied Materials & Interfaces 2023, 15, 28524-28535.
18. Chen, X. Y.; Armes, S. P. Surface Polymerization of Hydrophilic Methacrylates from Ultrafine Silica Sols in Protic Media at Ambient Temperature: A Novel Approach to Surface Functionalization Using a Polyelectrolytic Macroinitiator. Advanced Materials 2003, 15, 1558-1562.
19. Terayama, Y.; Kikuchi, M.; Kobayashi, M.; Takahara, A. Well-Defined Poly(Sulfobetaine) Brushes Prepared by Surface-Initiated ATRP Using a Fluoroalcohol and Ionic Liquids as the Solvents. Macromolecules 2011, 44, 104-111.
20. Jiang, W.; Irgum, K. Tentacle-Type Zwitterionic Stationary Phase, Prepared by Surface-Initiated Graft Polymerization of 3-[N,N-Dimethyl-N-(Methacryloyloxyethyl)-Ammonium] Propanesulfonate through Peroxide Groups Tethered on Porous Silica. Anal Chem 2002, 74, 4682-4687.
21. Zhang, Z.; Chen, S.; Chang, Y.; Jiang, S. Surface Grafted Sulfobetaine Polymers Via Atom Transfer Radical Polymerization as Superlow Fouling Coatings. The Journal of Physical Chemistry B 2006, 110, 10799-10804.
22. Zhang, Z.; Finlay, J. A.; Wang, L. F.; Gao, Y.; Callow, J. A.; Callow, M. E.; Jiang, S. Y. Polysulfobetaine-Grafted Surfaces as Environmentally Benign Ultralow Fouling Marine Coatings. Langmuir 2009, 25, 13516-13521.
23. Cheng, G.; Zhang, Z.; Chen, S. F.; Bryers, J. D.; Jiang, S. Y. Inhibition of Bacterial Adhesion and Biofilm Formation on Zwitterionic Surfaces. Biomaterials 2007, 28, 4192-4199.
24. Jiang, C.; Wang, G.; Hein, R.; Liu, N.; Luo, X.; Davis, J. J. Antifouling Strategies for Selective in Vitro and in Vivo Sensing. Chemical Reviews 2020, 120, 3852-3889.
25. Tugulu, S.; Klok, H.-A. Stability and Nonfouling Properties of Poly(Poly(Ethylene Glycol) Methacrylate) Brushes under Cell Culture Conditions. Biomacromolecules 2008, 9, 906-912.
26. Chen, W.-L.; Menzel, M.; Watanabe, T.; Prucker, O.; Rühe, J.; Ober, C. K. Reduced Lateral Confinement and Its Effect on Stability in Patterned Strong Polyelectrolyte Brushes. Langmuir 2017, 33, 3296-3303.
27. Ding, Z.; Chen, C.; Yu, Y.; de Beer, S. Synthetic Strategies to Enhance the Long-Term Stability of Polymer Brush Coatings. J Mater Chem B 2022, 10, 2430-2443.
28. Fu, J. C.; Schlenoff, J. B. Driving Forces for Oppositely Charged Polyion Association in Aqueous Solutions: Enthalpic, Entropic, but Not Electrostatic. Journal of the American Chemical Society 2016, 138, 980-990.
29. Kitano, H.; Imai, M.; Sudo, K.; Ide, M. Hydrogen-Bonded Network Structure of Water in Aqueous Solution of Sulfobetaine Polymers. Journal of Physical Chemistry B 2002, 106, 11391-11396.
30. Schlenoff, J. B. Zwitteration: Coating Surfaces with Zwitterionic Functionality to Reduce Nonspecific Adsorption. Langmuir 2014, 30, 9625-9636.
31. Chen, Y.; Yang, M.; Schlenoff, J. B. Glass Transitions in Hydrated Polyelectrolyte Complexes. Macromolecules 2021, 54, 3822-3831.
32. Ghostine, R. A.; Markarian, M. Z.; Schlenoff, J. B. Asymmetric Growth in Polyelectrolyte Multilayers. Journal of the American Chemical Society 2013, 135, 7636-7646.
33. Huang, H.; Zhang, C.; Crisci, R.; Lu, T.; Hung, H.-C.; Sajib, M. S. J.; Sarker, P.; Ma, J.; Wei, T.; Jiang, S.; Chen, Z. Strong Surface Hydration and Salt Resistant Mechanism of a New Nonfouling Zwitterionic Polymer Based on Protein Stabilizer TMAO. Journal of the American Chemical Society 2021, 143, 16786-16795.
34. Graul, T. W.; Schlenoff, J. B. Capillaries Modified by Polyelectrolyte Multilayers for Electrophoretic Separations. Analytical Chemistry 1999, 71, 4007-4013.
35. Salloum, D. S.; Olenych, S. G.; Keller, T. C. S.; Schlenoff, J. B. Vascular Smooth Muscle Cells on Polyelectrolyte Multilayers: Hydrophobicity-Directed Adhesion and Growth. Biomacromolecules 2005, 6, 161-167.
36. Arias, C. J.; Keller, T. C. S.; Schlenoff, J. B. Quasi-Spherical Cell Clusters Induced by a Polyelectrolyte Multilayer. Langmuir 2015, 31, 6436-6446.
37. Ghoussoub, Y. E.; Fares, H. M.; Delgado, J. D.; Keller, L. R.; Schlenoff, J. B. Antifouling lon-Exchange Resins. ACS Applied Materials and Interfaces 2018, 10, 41747-41756.
38. Müller, M.; Rieser, T.; Lunkwitz, K.; Meier-Haack, J. Polyelectrolyte Complex Layers: A Promising Concept for Antifouling Coatings Verified by in-Situ ATR-FTIR Spectroscopy. Macromolecular Rapid Communications 1999, 20, 607-611.
39. Thierry, B.; Winnik, F. M.; Merhi, Y.; Silver, J.; Tabrizian, M. Bioactive Coatings of Endovascular Stents Based on Polyelectrolyte Multilayers. Biomacromolecules 2003, 4, 1564-1571.
40. Mendelsohn, J. D.; Yang, S. Y.; Hiller, J.; Hochbaum, A. I.; Rubner, M. F. Rational Design of Cytophilic and Cytophobic Polyelectrolyte Multilayer Thin Films. Biomacromolecules 2003, 4, 96-106.
41. Sendra, M.; Yeste, M. P.; Gatica, J. M.; Moreno-Garrido, I.; Blasco, J. Direct and Indirect Effects of Silver Nanoparticles on Freshwater and Marine Microalgae (Chlamydomonas Reinhardtii and Phaeodactylum Tricornutum). Chemosphere 2017, 179, 279-289.
42. Tesler, A. B.; Kim, P.; Kolle, S.; Howell, C.; Ahanotu, O.; Aizenberg, J. Extremely Durable Biofouling-Resistant Metallic Surfaces Based on Electrodeposited Nanoporous Tungstite Films on Steel. Nat. Commun. 2015, 6, 8649.
43. Kooten, T. G. V. S., M.; Busscher, H. J. Development and Use of a Parallel-Plate Flow Chamber for Studying Cellular Adhesion to Solid Surfaces. J. Biomed. Mater. Res. 1992, 26, 725-738.
44. Sager, R., and Granick, S. Nutritional Studies with Chlamydomonas Reinhardi. Ann. N. Y. Acad. Sci. 1953, 56, 831-838.
45. Decher, G. Fuzzy Nanoassemblies: Toward Layered Polymeric Multicomposites. Science 1997, 277, 1232-1237.
46. Shibuya, N. P., R. S. A Kinetic Study of PEEK Sulfonation in Concentrated Sulfuric Acid by Ultraviolet Visible Spectroscopy. Polymer 1994, 35, 3237-3242.
47. Gu, Y.; Li, D. The Zeta-Potential of Glass Surface in Contact with Aqueous Solutions. Journal of Colloid and Interface Science 2000, 226, 328-339.
48. Montero, J. F.; Tajiri, H. A.; Barra, G. M.; Fredel, M. C.; Benfatti, C. A.; Magini, R. S.; Pimenta, A. L.; Souza, J. C. Biofilm Behavior on Sulfonated Poly(Ether-Ether-Ketone) (SPEEK). Mater. Sci. Eng. C. 2017, 70, 456-460.
49. Hariri, H. H.; Lehaf, A. M.; Schlenoff, J. B. Mechanical Properties of Osmotically Stressed Polyelectrolyte Complexes and Multilayers: Water as a Plasticizer. Macromolecules 2012, 45, 9364-9372.
50. Batys, P.; Zhang, Y.; Lutkenhaus, J. L.; Sammalkorpi, M. Hydration and Temperature Response of Water Mobility in Poly(Diallyldimethylammonium)-Poly(Sodium 4-Styrenesulfonate) Complexes. Macromolecules 2018, 51, 8268-8277.
51. Dubas, S. T.; Farhat, T. R.; Schlenoff, J. B. Multiple Membranes from “True” Polyelectrolyte Multilayers. Journal of the American Chemical Society 2001, 123, 5368-5369.
52. Schlenoff, J. B.; Dubas, S. T.; Farhat, T. Sprayed Polyelectrolyte Multilayers. Langmuir 2000, 16, 9968-9969.
53. Kurtz, I. S.; Sui, S.; Hao, X.; Huang, M.; Perry, S. L.; Schiffman, J. D. Bacteria-Resistant, Transparent, Free-Standing Films Prepared from Complex Coacervates. ACS Applied Bio Materials 2019, 2, 3926-3933.
54. Zhu, X.; Jańczewski, D.; Lee, S. S. C.; Teo, S. L.-M.; Vancso, G. J. Cross-Linked Polyelectrolyte Multilayers for Marine Antifouling Applications. ACS Applied Materials & Interfaces 2013, 5, 5961-5968.
55. Picart, C.; Mutterer, J.; Richert, L.; Luo, Y.; Prestwich, G. D.; Schaaf, P.; Voegel, J. C.; Lavalle, P. Molecular Basis for the Explanation of the Exponential Growth of Polyelectrolyte Multilayers. Proceedings of the National Academy of Sciences of the United States of America 2002, 99, 12531-12535.
56. Laugel, N.; Betscha, C.; Winterhalter, M.; Voegel, J. C.; Schaaf, P.; Ball, V. Relationship between the Growth Regime of Polyelectrolyte Multilayers and the Polyanion/Polycation Complexation Enthalpy. Journal of Physical Chemistry B 2006, 110, 19443-19449.
57. Porcel, C.; Lavalle, P.; Ball, V.; Decher, G.; Senger, B.; Voegel, J. C.; Schaaf, P. From Exponential to Linear Growth in Polyelectrolyte Multilayers. Langmuir 2006, 22, 4376-4383.
58. Xing, P.; Robertson, G. P.; Guiver, M. D.; Mikhailenko, S. D.; Wang, K.; Kaliaguine, S. Synthesis and Characterization of Sulfonated Poly(Ether Ether Ketone) for Proton Exchange Membranes. Journal of Membrane Science 2004, 229, 95-106.
59. Priftis, D.; Laugel, N.; Tirrell, M. Thermodynamic Characterization of Polypeptide Complex Coacervation. Langmuir 2012, 28, 15947-15957.
60. Liu, C.; Lee, J.; Ma, J.; Elimelech, M. Antifouling Thin-Film Composite Membranes by Controlled Architecture of Zwitterionic Polymer Brush Layer. Environmental Science & Technology 2017, 51, 2161-2169.
61. Feng, Z.; Feng, X.; Lu, X. Bioinspired N-Oxide-Based Zwitterionic Polymer Brushes for Robust Fouling-Resistant Surfaces. Environmental Science & Technology 2023, 57, 7298-7308.
62. Beyer, C. D.; Thavalingam, S.; Guseva, T.; Schardt, L.; Zimmermann, R.; Werner, C.; Dietze, P.; Bandow, J. E.; Metzler-Nolte, N.; Rosenhahn, A. Zwitterionic Peptides Reduce Accumulation of Marine and Freshwater Biofilm Formers. ACS Applied Materials & Interfaces 2021, 13, 49682-49691.
63. Hunter, R. J. Introduction to Modern Colloid Science, Ch. 7 & 8; Oxford University Press: Oxford, 1993. p 338.
64. Howell, D.; Behrends, B. A Review of Surface Roughness in Antifouling Coatings Illustrating the Importance of Cutoff Length. Biofouling 2006, 22, 401-410.
65. Ciriminna, R.; Bright, F. V.; Pagliaro, M. Ecofriendly Antifouling Marine Coatings. ACS Sustain Chem Eng 2015, 3, 559-565.
66. Petronis, Š.; Berntsson, K.; Gold, J.; Gatenholm, P. Design and Microstructuring of Pdms Surfaces for Improved Marine Biofouling Resistance. Journal of Biomaterials Science, Polymer Edition 2000, 11, 1051-1072.
67. Schumacher, J. F.; Carman, M. L.; Estes, T. G.; Feinberg, A. W.; Wilson, L. H.; Callow, M. E.; Callow, J. A.; Finlay, J. A.; Brennan, A. B. Engineered Antifouling Microtopographies—Effect of Feature Size, Geometry, and Roughness on Settlement of Zoospores of the Green Alga Ulva. Biofouling 2007, 23, 55-62.
68. Scardino, A. J.; Harvey, E.; De Nys, R. Testing Attachment Point Theory: Diatom Attachment on Microtextured Polyimide Biomimics. Biofouling 2006, 22, 55-60.
69. Cui, Y.; Yuan, W. Q.; Cao, J. Effects of Surface Texturing on Microalgal Cell Attachment to Solid Carriers. Int. J. Agric. & Biol. Eng 2013, 6, 44-54.
70. Dubas, S. T.; Schlenoff, J. B. Polyelectrolyte Multilayers Containing a Weak Polyacid: Construction and Deconstruction. Macromolecules 2001, 34, 3736-3740.
71. Dautzenberg, H.; Kriz, J. Response of Polyelectrolyte Complexes to Subsequent Addition of Salts with Different Cations. Langmuir 2003, 19, 5204-5211.
72. Perry, S. L.; Li, Y.; Priftis, D.; Leon, L.; Tirrell, M. The Effect of Salt on the Complex Coacervation of Vinyl Polyelectrolytes. Polymers 2014, 6, 1756-1772.
73. Xu, N.; Oltmanns, A.; Zhao, L.; Girot, A.; Karimi, M.; Hoepfner, L.; Kelterborn, S.; Scholz, M.; Beißel, J.; Hegemann, P.; Bäumchen, O.; Liu, L.-N.; Huang, K.; Hippler, M. Altered N-Glycan Composition Impacts Flagella-Mediated Adhesion in Chlamydomonas Reinhardtii. eLife 2020, 9, e58805.
74. Ederth, T.; Nygren, P.; Pettitt, M. E.; Ostblom, M.; Du, C.; Broo, K.; Callow, M. E.; Callow, J.; Liedberg, B. Anomalous Settlement Behavior of Ulva Linza Zoospores on Cationic Oligopeptide Surfaces. Biofouling 2008, 24, 303-12.
75. Ge, S.; Agbakpe, M.; Zhang, W.; Kuang, L. Heteroaggregation between PEI-Coated Magnetic Nanoparticles and Algae: Effect of Particle Size on Algal Harvesting Efficiency. ACS Appl. Mater. Interfaces 2015, 7, 6102-8.

What is claimed:

1. An article comprising a coating for reducing fouling on a surface of an article, wherein the coating comprises a polyelectrolyte complex comprising at least one negatively charged polyelectrolyte polymer, at least one positively charged polyelectrolyte polymer, and wherein the coating has a glass transition temperature of at least 45° C. when in contact with an aqueous medium.

2. The article of claim 1, wherein the negatively charged polyelectrolyte polymer comprises a hydrocarbon backbone and one or more aryl groups pendant to the backbone, wherein each aryl group comprises at least one anionic group or the negatively charged polyelectrolyte polymer comprises a backbone with one or more aryl groups, wherein each aryl group comprises at least one anionic group.

3. The article of claim 2, wherein the anionic group comprises a sulfonate group, a phosphate group, or phosphonate group.

4. The article of claims 2, wherein the aryl group comprises a phenyl group.

5. The article of claim 1, wherein negatively charged polyelectrolyte polymer comprises a backbone with one or more phenyl groups, wherein each phenyl group has one or more sulfonate groups covalently bonded to the aryl group.

6. The article of claim 1, wherein the negatively charged polyelectrolyte polymer comprises a sulfonated polyparaphenylene, a sulfonated polyetherether ketone, a sulfonated polysulfone, a sulfonated polyarylene, or a sulfonated polyarylene sulfone.

7. The article of claim 1, wherein the positively charged polyelectrolyte polymer comprises a plurality of quaternary ammonium groups covalently bonded to the positively charged polyelectrolyte polymer.

8. The article of claim 7, wherein the quaternary ammonium group comprises a nitrogen-bearing heteroaryl group or a nitrogen-bearing cycloalkyl group, wherein nitrogen is alkylated.

9. The article of claim 1, wherein the positively charged polyelectrolyte polymer comprises a protonated or alkylated poly(pyridine), a protonated or alkylated poly(imidazole), a protonated or alkylated a poly(piperidine), or a protonated or alkylated poly(amine).

10. The article of claim 1, wherein the positively charged polyelectrolyte polymer comprises poly(diallyldimethylammonium chloride) (PDADMA), poly(vinylbenzyltrimethylammonium) (PVBTA), ionenes, poly(acryloxyethyltrimethyl ammonium chloride), poly(methacryloxy(2-hydroxy)propyltrimethyl ammonium chloride), and copolymers thereof; polyelectrolytes comprising a pyridinium group such as poly(N-methylvinylpyridinium) (PMVP), including poly(N-methyl-2-vinylpyridinium) (PM2VP), and copolymers thereof; poly(allylaminehydrochloride) (PAH), polyvinylamine, polyethyleneimine (PEI); a polysulfonium, or a polyphosphonium.

11. The article of claim 1, wherein the positively-charged polyelectrolyte and the negatively-charged polyelectrolyte has an average charge density of about 0.1 to about 2.0 per repeat unit.

12. The article of claim 1, wherein the coating has a thickness of about 10 nanometers to about 1 millimeter.

13. The article of claim 1, wherein the coating has a glass transition temperature of at least 80° C. when in contact with an aqueous media.

14. The article of claim 1, wherein the coating has a net negative charge density greater than zero to about 10%.

15. The article of claim 1, wherein the article comprises a hull of a nautical vessels, a pipe, a dock, a cable, a chain, a rope, a buoy, a weight, a propellor, or an anchor.

16. An article comprising a coating for reducing fouling on a surface of an article, wherein the coating is produced by the method comprising applying to the surface of the article a coating comprising a polyelectrolyte complex, the method comprising applying to the surface a composition comprising at least one negatively charged polyelectrolyte polymer, at least one positively charged polyelectrolyte polymer, and a solvent, and wherein the coating has a glass transition temperature of at least 45° C. when in contact with an aqueous media.

17. The article of claim 16, wherein the solvent comprises water, an organic solvent, or a combination thereof.

18. The article of claim 16, wherein the solvent comprises water and formamide.

19. The method of claim 16, wherein the coating is produced by the method comprising
(a) applying to the surface of the article a coating comprising a polyelectrolyte complex, the method comprising applying to the surface a composition comprising at least one negatively charged polyelectrolyte polymer, at least one positively charged polyelectrolyte polymer, and a solvent to produce a first coating;
(b) applying formamide to the first coating to produce a fused coating; and
(c) rinsing the fused coating with water to substantially remove the formamide from the fused coating, wherein the fused coating has a glass transition temperature of at least 45° C. when in contact with an aqueous media.

20. An article comprising a coating for reducing fouling on a surface of an article, wherein the coating is produced by the method comprising sequentially applying to the surface of the article at least one negatively charged polyelectrolyte polymer composition and at least one positively charged polyelectrolyte polymer composition, and wherein the coating has a glass transition temperature of at least 45° C. when in contact with an aqueous media.
